(19) United States
(12) Patent Application Publication
(10) Pub. No.: US 2007/0014192 A1
(43) Pub. Date: Jan. 18, 2007

(54) Timepiece

(75) Inventors: Frank H. Spoto, East Chatham, NY (US); Robert M. Carangelo, Glastonbury, CT (US)

Correspondence Address: DAVID LEWIS, 1250 AVIATION AVE., SUITE 200B, SAN JOSE, CA, 95110, US

(73) Assignee: Now Is Forever, LLC

(21) Appl. No.: 11/182,620

(22) Filed: Jul. 15, 2005

(51) Int. Cl. G04B 19/20; G04B 19/00; G04B 25/00

(52) U.S. Cl. 368/77; 368/223

(57) ABSTRACT

In an embodiment, a timepiece includes orbs that represent planets. In an embodiment, a timepiece includes one or more philosophical messages. In an embodiment, a threshold detector detects when an input is associated with a level that is greater than a level associated with an average of the input.

### TECHNICAL FIELD

An embodiment of the invention is related to timepieces. Another embodiment of the invention is related to detectors.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

Analog timepieces typically have two or three hands. When there are two hands, a longer of the two hands is used for the minute hand, and a shorter of the two hands is used for the hour hand. When there are three hands, the third hand is used for the second hand, and is either the same length or longer than the minute hand. Watches often require the use of a stem, crown, or buttons for inputting information or setting the time.

Detectors are used with televisions for detecting infrared light generated by a remote control.

### BRIEF DESCRIPTION OF THE FIGURES

In the following drawings like reference numbers are used to refer to like elements. Although the following figures depict various examples of the invention, the invention is not limited to the examples depicted in the figures.

FIG. 1 shows an example of a timepiece according to an embodiment of the invention.

FIG. 2 shows an example of a circuit for the timepiece of FIG. 1.

FIG. 3 shows a block diagram of an embodiment of part of the circuit of FIG. 2.

FIG. 4 shows a block diagram of an embodiment of part of the circuit of FIG. 3.

FIG. 5 is a graph of light intensity verses time when a shadow passes over the timepiece of FIG. 1.

FIG. 6 is a graph of voltage verses time caused by the changes in light intensity plotted in FIG. 5.

FIG. 7 is a graph of light intensity verses time when a light is briefly shined on the timepiece of FIG. 1.

FIG. 8 is a graph of voltage verses time caused by the variation in light intensity plotted in FIG. 7.

FIG. 9A shows an illustration of an embodiment of a method of inputting information into the timepiece of FIG. 1 via a photosensor.

FIG. 9B shows a block diagram of an example of a circuit for detecting phase modulated input signals.

FIG. 10 shows an example of a remote control that can be used for inputting information into the timepiece of FIG. 1.

FIG. 11 shows an example of a face of the timepiece of FIG. 1.

FIGS. 12A and 12B show another example of a face of the timepiece of FIG. 1.

FIG. 13A shows a flowchart of an example of a method for setting the timepiece of FIG. 1.

FIG. 13B shows a flowchart of another example of a method for setting the timepiece of FIG. 1.

FIG. 14 shows a flowchart of an example of a method of handling a failing battery.

FIG. 15 shows a flowchart of an example of a method for handling timeouts.

FIG. 16 is a perspective view of an embodiment of the timepiece of FIG. 1, which has the face of FIG. 11, absent the cover.

FIG. 17 is a perspective view of the timepiece of FIG. 1, which has the face of FIGS. 12A and B, absent the cover.

FIG. 18 is a side view opposite the crown of an embodiment of the timepiece of FIG. 16.

FIG. 19 is a side view from the 6:00 end of an embodiment of the timepiece of FIG. 16.

FIG. 20 is a side view from the crown end of an embodiment of the timepiece of FIG. 16.

FIG. 21 is a side view from the 12:00 end of and embodiment of the timepiece of FIG. 1.

FIG. 22 shows a bottom view of an embodiment of the timepiece of FIG. 1.

FIG. 23 is a side view opposite the crown of an embodiment of the timepiece of FIG. 17.

FIG. 24 is a side view from the 6:00 end of an embodiment of the timepiece of FIG. 17.

FIG. 25 is a side view from the crown end of an embodiment of the timepiece of FIG. 17.

FIG. 26 is a side view from the 12:00 end of and embodiment of the timepiece of FIG. 17.

FIG. 27 shows a bottom view of an embodiment of the timepiece of FIG. 17.

FIGS. 28A-D show examples of various display modes of another embodiment of the timepiece of FIG. 1.

### DETAILED DESCRIPTION OF THE DRAWINGS

Although various embodiments of the invention may have been motivated by various deficiencies with the prior art, which may be discussed or alluded to in one or more places in the specification, the embodiments of the invention do not necessarily address any of these deficiencies. In other words, different embodiments of the invention may address different deficiencies that may be discussed in the specification. Some embodiments may only partially address some deficiencies that may be discussed in the specification, and some embodiments may not address any of these deficiencies.

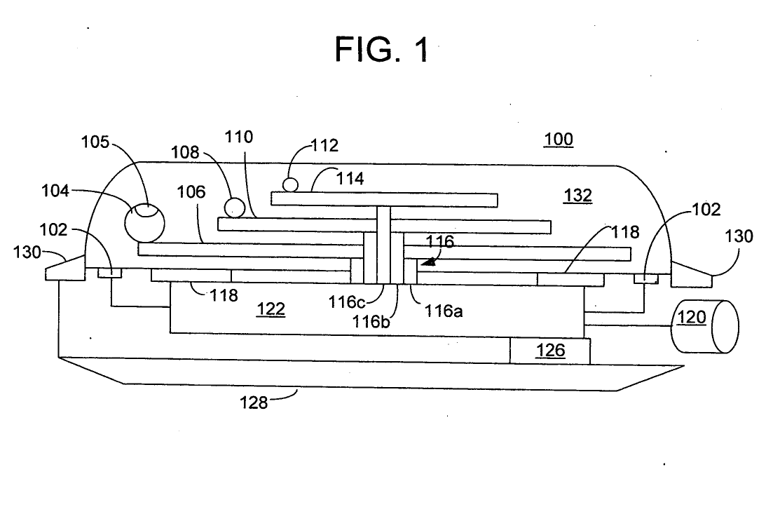

In general, at the beginning of the discussion of each of FIGS. 1-12 is a brief description of each element, which may have no more than the name of each of the elements in the one of FIGS. 1-12 that is being discussed. After the brief description of each element, each element is further discussed in numerical order. In general, each of FIGS. 1-28D is discussed in numerical order and the elements within FIGS. 1-28D are also usually discussed in numerical order to facilitate easily locating the discussion of a particular element. Nonetheless, there is no one location where all of the information of any element of FIGS. 1-28D is necessarily located. Unique information about any particular element or any other aspect of any of FIGS. 1-28D may be found in, or implied by, any part of the specification.

FIG. 1 shows an example of a timepiece 100. Timepiece 100 includes photosensor 102, orb 104 having marking 105 and attached to disc 106, orb 108 attached to disc 110, orb 112 attached to disc 114, axle system 116 having spindles 116a, 116b, and 116c, display 118, information entry system 120, electronics and motion mechanism 122, power source 126, removable back cover 128, bezel 130, and cover 132. In other embodiments, timepiece 100 may not include all of the components listed above or may include other components instead of and/or in addition to those listed above.

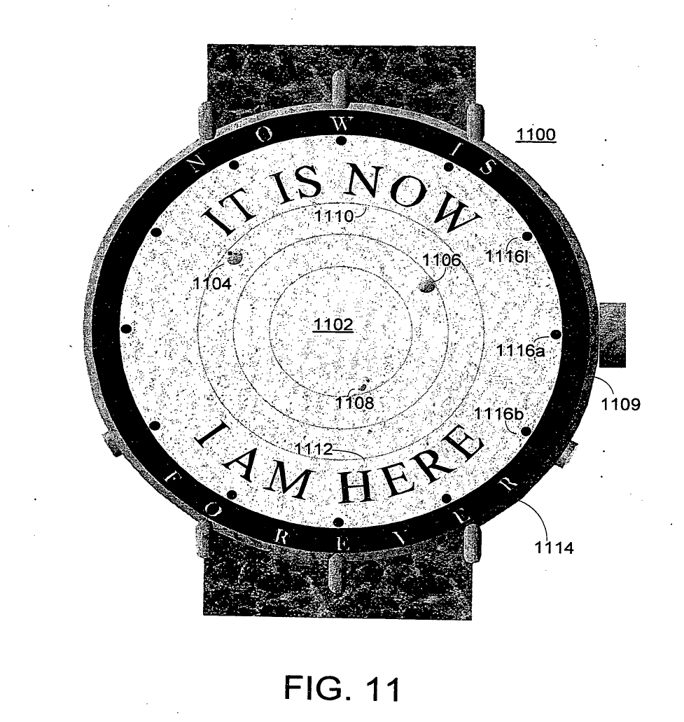

Although FIG. 1 depicts a watch for timepiece 100, timepiece 100 may be any type of timepiece, such as a wall clock, grandfather clock, or a desk clock. In an embodiment, timepiece 100 is capable of displaying messages in addition to the time. For example, the message may be a philosophical and/or educational message while conveying the time. Examples of messages that may be displayed are discussed below and/or illustrated in conjunction with the discussion of display 118 and the discussion of FIGS. 11, 12A, 12B, and 17. Photosensor 102 may be used for entering information into timepiece 100. For example, photosensor 102 may be used for setting the time, date, and/or other functions. Alternatively, photosensor 102 may supply power to timepiece 100 in addition to, or instead of, receiving information. Photosensor 102 may be any detector of light and/or means of converting light to power. For example, photosensor 102 may include any combination of one or more photodiodes, one or more phototransistors, and/or one or more other types of photocells.

Photosensor 102 may be used as an alternative to inputting information via a stem, crown, or buttons. Timepiece 100 may require a combination of input from photosensor 102 and stem, crown, and/or buttons. Photosensor 102 can be used to detect the presence or absence of light caused by a hand being waved over timepiece 100 or by a variety of other means.

The combination of orbs 104, 108, and 112 and discs 106, 110, and 114 forms a system for marking the time. Orb 104 has marking 105 and is attached to disc 106. Marking 105 is discussed further below after the discussion of orbs 104, 108, and 112 and discs 106, 110, and 114. Orb 104 rotates with disc 106 at a rate appropriate for indicating a current hour by marking a location on timepiece 100 corresponding to the current hour. Similarly, orb 108 rotates with disc 110 at a rate appropriate for indicating a current minute by marking a location on timepiece 100 corresponding to the current minute. Orb 112 rotates with disc 114 at a rate appropriate for representing a current second by marking a location on timepiece 100 corresponding to the current second.

In an embodiment, orbs 104, 108, and 112 are attached to discs 106, 110, and 114, respectively, in a manner that is relatively insensitive to vibrations. Orbs 104, 108, and 112 may be attached to the tops, bottoms, and/or sides of discs 106, 110, and 114. Discs 106, 110, and 114 rotate on axle system 116, which may include three concentric spindles. Discs 106, 110, and 114 may be transparent. In an embodiment, the ratio of the diameters of discs 106, 110, and 114 is 1.29:0.93:0.5. In an embodiment, the ratio of the diameters of discs 106, 110, and 114 is 1:0.95:0.381 (or 2.62:2.49:1 or 1.31:1.25:.5). In an embodiment, the ratio of the diameters of discs 106, 110, and 114 is, or is approximately, 2.58:1.87:1 (or 1:.723:.387). In an embodiment, discs 106, 110, and 114 are, or are approximately, 2.58 cm, 1.87 cm, and 1 cm in diameter, respectfully. In an embodiment, the spacing between discs 106, 110, and 114 is kept as small as possible without risking contacting one another, which is a spacing that is somewhat larger than the variations in height of the surface of discs 106, 110, and 114 (e.g., between 25μ and 200μ).

Since orbs 104, 108, and 112 are three dimensional, orbs 104, 108, and 112 create interesting effects from the shadows caused by the lighting (e.g., the ambient lighting). Additionally, the placement and sizes of orbs 104, 108, and 112 conveys an educational message about the location the planets represented by orbs 104, 108, and 112 within the planetary system associated with Earth. In an embodiment, the orbs 104, 108, and 112 are light colored and have a reflective surface.

In an alternative embodiment, orbs 104, 108, and 112 are replaced by other objects, such as objects that suggest planets. For example, orbs 104, 108, and 112 may be replaced by three circles that lie flat on the face of timepiece 100, perpendicular to the face of timepiece 100, or at any other angle to the face of timepiece 100. Similarly, discs 106, 110, and 114 may be replaced by rings supported by one or more spokes. Discs 106, 110, and 114 may be replaced by hands having a length that is the same as the radii of discs 106, 110, and 114, respectively. Alternatively, orbs 104, 108, and 112 may move on circular or noncircular (e.g., elliptical) tracks replacing or hiding discs 106, 110, and 114. In another embodiment, orbs 104, 108, and 112 and discs 106, 110, and 114 are replaced with images of orbs or planets rotating and/or orbiting on a display screen, such as a Liquid Crystal Display (LCD), Light Emitting Diode (LED), electrophoretic, cathode ray or plasma display screen.

In an embodiment, the size order of orbs 104, 108, and 112 is the same as the size order as three particular planets of Earth's solar system. In another embodiment, in addition to being in the same size order as the three planets, orbs 104, 108, and 112 have the same ratio of sizes to one another as three particular planets have to one another. In an embodiment, the sizes of discs 106, 110, and 114 have the same size ordering as the orbits of three particular planets. In another embodiment, the ratio of the sizes of discs 106, 110, and 114 to one another is the same as the ratio of the orbits of three particular planets to one another. In an embodiment, discs 106, 110, and 114 are each, or are each approximately, 100μ or 4 mills thick.

In an embodiment, orbs 104, 108, and 112 may have the same approximate color and relative distance from a depiction of the sun, as the actual planets that orbs 104, 108, and 112 represent. In an embodiment, the tint and direction of rotation of orbs 104, 108, and 112 is approximately the same as or the same as that of three particular planets of Earth's solar system when viewed from a perspective that is south of the respective ecliptic plates of these particular planets. In an embodiment the direction of rotation of orbs 104, 108, and 112 is clockwise. In another embodiment the direction of rotation of orbs 104, 108, and 112 is counterclockwise. If the direction of rotation is counter clockwise, the face of timepiece 100 may be appropriately labeled so that the positions of orbs 104, 108, and 112 indicate the time, which may be a labeling in which the positions of the labels mirror the positioning in an embodiment in which orbs 104, 108 and 112 rotate clockwise.

Any three particular planets may be chosen. In an embodiment, the three planets are Earth, Venus, and Mercury. In an alternative embodiment, the planets are Mars, Earth, and Venus. In another embodiment, the planets are Uranus, Jupiter, and Saturn. In an embodiment, orbs 104, 108, and 112 are, or are approximately, 2.6 mm, 2.5 mm, and 1 mm, respectively. In an embodiment, there may only be two orbs one for indicating the minutes and one for indicating the hours. In an embodiment, there may be more than three orbs representing planets.

Marking 105 is a marking that is likely to convey a philosophical message. In an embodiment in which orb 104 represents Earth, marking 105 indicates to the observer the observer's present location, which is Earth. In an embodiment, marking 105 may be any marking that is likely to convey the message, “You are here.” In an embodiment, marking 105 is a dot, which is reminiscent of dots for indicating a current location that are placed on maps in various complexes, such as malls, apartment complexes, highways, and museums. Marking 105 may be any of a variety of colors. In an embodiment, making 105 is red. In another embodiment, marking 105 is orange. In another embodiment, an arrow may be attached to disc 106 in a manner in which the arrow points towards orb 104, and is therefore likely to convey the message of “You are here.” The arrow may be in addition to, or instead of, a dot.

In an embodiment, display 118 is a Liquid Crystal Display (LCD). LCDs have low power consumption due to their low current requirements, and are therefore suited for embodiments in which low power consumption is desirable. However, any of a number of other displays may be used instead, such as Light Emitting Diodes (LED), electrophoretic displays, plasma displays, and cathode ray tubes. Display 118 displays messages, such as “NOW IS FOREVER.” In another embodiment, display 118 may display the time and/or another message in addition to or instead of “NOW IS FOREVER.” The messages may be of a philosophical nature. The messages may relate to an outlook of time. Display 118 may display information relevant to setting timepiece 100. For example, display 118 may display mode information, information relevant to the current time, date, and alarm settings.

Information entry system 120 may be used for entering information as an alternative to, or in addition to, photosensor 102. Information entry system 120 may be a button, a system of buttons, one or more touch sensitive pads, one or more heat sensitive pads, and/or one or more acoustic sensors, for example. Alternatively, timepiece 100 may have only one of photosensor 102 and information entry system 120. In another embodiment, there are two types of information that may be entered via photosensor 102 and information entry system 120. Only one of photosensor 102 and information entry system 120 is used for entering one type of information, while the other is used for entering the other type of information. In another embodiment, there are also two types of information that may be entered via photosensor 102 and information entry system 120. As in the prior embodiment, only one of photosensor 102 and information entry system 120 is used for entering the first type of information. However, in contrast to the prior embodiment, both photosensor 102 and information entry system 120 may be used for entering the second type of information. In another embodiment, there are three types of information that may be entered via photosensor 102 and information entry system 120. Only one of photosensor 102 and information entry system 120 is used for entering the first type of information, while only the other may be used for entering the second type of information, and both may be used for entering the third type of information.

In an embodiment, timepiece 100 may be operated by shining a light source on it. In an embodiment, the light source is modulated to form one of a set of very specific patterns, to which the timepiece 100 is configured to respond to. The patterns may be phase modulated and/or amplitude modulated. In an embodiment, the patterns used for setting timepiece 100 using shadows are the same as the patterns of light used for setting timepiece 100. In another embodiment, the patterns used for setting timepiece 100 are different depending on whether light or shadows are used for setting timepiece 100. In an embodiment, the light source used for setting timepiece 100 may be a remote control that creates specific modulated patterns of near-infrared light to send messages to timepiece 100.

Electronics and motion mechanism 122 rotates discs 106, 110, and 114 in a manner appropriate for indicating the time. Electronics and motion mechanism 122 may use a purely mechanical windup mechanism for rotating discs 106, 110, and 114. Alternatively, electronics and motion mechanism 122 may use one or more electro mechanical motors coupled to spindles 116a, 116b, and 116c for rotating discs 106, 110, and 114, respectively. Electronics and motion mechanism 122 controls the messages displayed on display 118. Electronics and motion mechanism 122 receives and processes information received from photosensor 102 and/or information entry system 120. Electronics and motion mechanism 122 may include an alarm function. Electronics and motion mechanism 122 may include passive and/or low power circuitry for interpreting the signals from photosensor 102, which then sends the interpreted signals to a logic portion of electronics and motion mechanism 122. In an embodiment, timepiece 100 does not have any moving parts and/or is purely electrical, such as the embodiment in which orbs 104, 108, and 112 and discs 106, 110, and 114 are replaced by a display having images of planets orbiting. In one embodiment that does not include the moving parts, no special seals are included. Since there are no moving parts in this embodiment, there is a reduced concern of dust preventing gears or other moving parts from moving.

Power source 126 supplies power to electronics and motion mechanism 122 and/or display 118. Power source 126 may be a battery, a photocell, and/or a motion activated generator, for example. Removable back 128 may be removed for the sake of replacing the power source 126, performing repairs, and/or replacing electronics and motion mechanism 122, for example. In an embodiment, the face of timepiece 100 is 3.25 cm in diameter.

In an embodiment, power source 126 stores 100 or more Joules of energy. In an embodiment, orb 114 is 2 mm in diameter and made from solid plastic planet. In an embodiment, disc 116 is made from titanium. In an embodiment, the materials chosen for the moving parts of the timepiece 100 are such that the work required to move any one of the discs 106, 110, and 114 for an entire year is less than 0.26%, 0.261%, or 0.27% of the energy stored in power source 126.

Bezel 130 holds cover 132 in place. Cover 132 may be transparent and may protect the rest of timepiece 100 from debris, while allowing the face of timepiece 100 to be viewed.

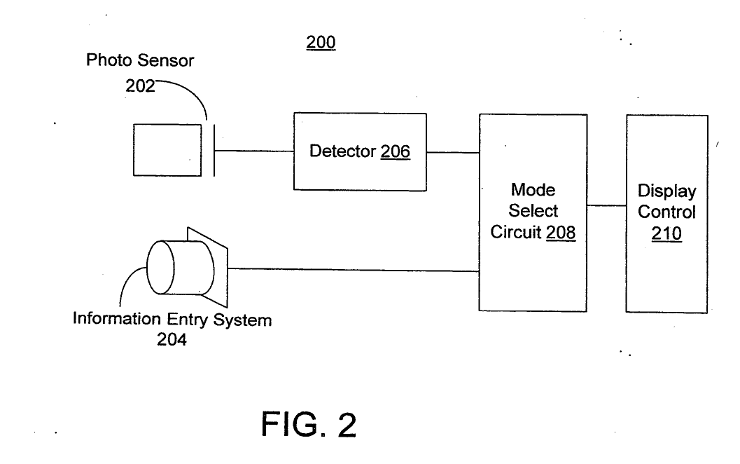

FIG. 2 shows an example of a circuit 200 for timepiece 100. Circuit 200 includes photosensor 202, information entry system 204, detector 206, mode selection circuitry 208, and display control 210. In other embodiments, circuit 200 may not include all of the components listed above or may include other components instead of and/or in addition to those listed above.

Photosensor 202 may be the same as photosensor 102. Information entry system 204 may be the same as information entry system 120. Consequently, information entry system 204 and photosensor 202 may be alternative modes of entering information into timepiece 100. Photosensor 202 may be configured for detecting a hand covering and uncovering the photosensor for inputting information. Detector 206, mode selection circuitry 208, and display control 210 may make up at least part of electronics and motion mechanism 122.

Detector 206 detects those signals from photosensor 202 that contain information being sent to circuit 200. Detector 206 may include one or more passive filters for filtering out signals that are expected not to contain information and/or are expected to contain primarily noise, for example. In an embodiment, timepiece 100 is configured for receiving signals that lie within a given frequency range. Detector 206 may filter out all but signals that are in the expected frequency range of the information carrying signals. For example, detector 206 may include a high pass filter for filtering out changes in the signal from photosensor 102 that are lower than the expected frequency range of the information signals. Other filters may also be included instead of, or in addition to, high frequency filter 206. For example, detector 206 may include a low pass filter for filtering out those frequencies that are higher than the information carrying portion of the information carrying signals. Alternatively, detector 206 may contain a band pass filter that only allows the portion of signals within the frequency ranges expected to be carrying information to pass through the filter. Detector 206 may be a passive device (e.g., including one or more passive filters and/or other passive devices). Using one or more passive devices for detector 206 facilitates keeping the amount of power consumed lower than were an active device used. In an alternative embodiment, an active device is used for detector 206.

Mode selection circuitry 208 may be used for selecting the mode of timepiece 100. The modes may include operational modes such as a mode in which a digital readout of the time and/or date are displayed and a mode in which other messages may be displayed. The modes may include modes for setting timepiece 100, such as modes for setting the time, which may include setting the hour, minute, day, month, and/or year. The modes may include one or more modes for entering a message to display instead of, or in addition to, both of, one of, or part of the time and/or date.

Display control 210 controls display 118. Display control 210 controls whether display 118 displays the time, date, and/or other messages. Display control 210 accepts input from mode selection circuitry 208, which is used to determine how to control display 118. For example, whether display 118 displays the time, date, or another message may be determined by which mode is selected via signals from either photosensor 202 or information entry system 204, which cause mode selection circuitry 208 to select a mode, which in turn determines what display control 210 causes display 118 to display. Display control 210 may cause display 118 to display information relevant to setting the mode and/or setting timepiece 100.

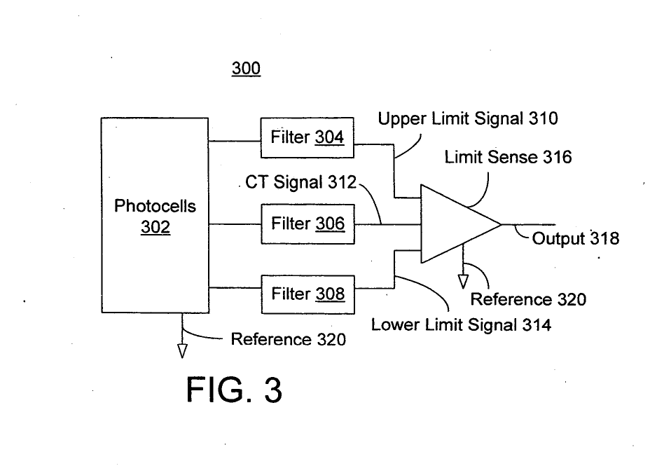

FIG. 3 shows a block diagram of a circuit 300, which is one example of an embodiment of part of circuit 200 (FIG. 2). Circuit 300 includes photocells 302, filter 304, filter 306, filter 308, upper limit signal 310, Center Tap (CT) signal 312, lower limit signal 314, limit sense 316, output 318, and reference 320. In other embodiments, circuit 300 may not include all of the components listed above or may include other components instead of and/or in addition to those listed above.

Photocells 302 may include only one photocell or may include multiple photocells 302. Photocells 302 may be placed in series to generate a stronger signal. Photocells 302 produce a signal that depends upon the light level. Photocells 302 may be an embodiment of photosensor 202. Photocells 302 may be a stack of photocells in which all of the photocells in the stack are in one location or may include two or more independent stacks of photocells each stack being located at a different position on timepiece 100. The signal produced by photocells 302 may increase with increases of light levels. Filter 304, filter 306, filter 308, upper limit signal 310, CT signal 312, lower limit signal 314, limit sense 316, and output 318 form an embodiment of detector 206.

Filters 304, 306, and 308 extract three different voltage levels, respectively, from photocells 302. Filters 304 and 308 average the light signal over a significantly longer time period than filter 306. Filter 304 outputs a high voltage, upper limit signal 310, which serves as an upper limit that is used as an upper threshold. Filter 308 outputs a low voltage, lower limit signal 314, which serves as a lower limit that is used as a low threshold. The output of filter 306, CT signal 312, tracks changes in the light level, and is usually a voltage that is between upper limit signal 310 and lower limit signal 314. Since CT signal 312 is between upper limit signal 310 and lower limit signal 314, when a shadow covers photocells 302, CT signal 312 transitions below lower limit signal 314. In this specification the terms “transitions” and “crosses” may be substituted one for another in phrases such as “transitions above” or “transitions below.” Similarly, when a light pulse is incident on photocells 302, CT signal 312 transitions above upper limit signal 310.

More specifically, when a high frequency change in light occurs CT signal 312 changes by a greater amount than upper limit signal 310 and lower limit signal 314. The upper limit signal 310 and lower limit signal 314 change with the average voltage level that is being output by photocells 302. Consequently, when the ambient light is greater upper limit signal 310 and lower limit signal 314 are both greater. Similarly, when the ambient light is lower upper limit signal 310 and lower limit signal 314 are both lower. If the voltage of CT signal 312 crosses that of upper limit signal 310 or lower limit signal 314, then it is expected that that the high frequency change in light is intended to be an input signal for changing the mode of timepiece 100 and/or setting timepiece 100.

Limit sense 316 senses whether CT signal 312 has crossed either the upper threshold established by upper limit signal 310 or the lower threshold established by lower limit signal 314. Output 318 is the output of limit sense 316. Output 318 is sent to the logic part of electronics and motion mechanism 122 (FIG. 1). In an embodiment, limit sense 316 includes two voltage comparators that are arranged in parallel to one another within circuit 300. In an embodiment, limit sense outputs a signal, output 318, only if limit sense 316 senses that CT signal 312 has crossed one of the thresholds. In an alternative embodiment, output 318 normally outputs a signal, and the signal is interrupted when CT signal 312 crosses one of the thresholds.

The bi-directional threshold detection capability of circuit 300 can use either a shadow or any near-infrared emitter to activate the circuit 200 (FIG. 2) for inputting information. In an embodiment, output 318 is the same no matter which threshold is crossed. In this embodiment, it would not matter if the input signals were generated by keeping the photocells 302 covered and removing the covering for brief periods or whether the signals are generated by keeping the photocells 302 exposed to light and covering photocells 302 for brief periods. Either way, as long as the patterns of change in light received by photocells 302 are the same, the same output 318 is produced. In an alternative embodiment, output 318 is different depending on which threshold was crossed. In this embodiment, the different ways of entering information (causing a crossing of the high threshold or a crossing of the low threshold) may be used for setting and/or activating different modes. In an embodiment, output 318 may include two different lines. One of the two lines carries a signal resulting from crossing the high threshold, and the other of the two lines carries a signal resulting from crossing the low threshold. Reference 320 could be a reference to ground, which keeps the voltage level of the photocells 302 and limit sense 316 from floating. In an embodiment, in which photocells 302 includes multiple stacks of photocells whose outputs are being compared, reference 320 ensures that the voltage difference from the photocells represents a difference in lighting and not a difference in reference voltages.

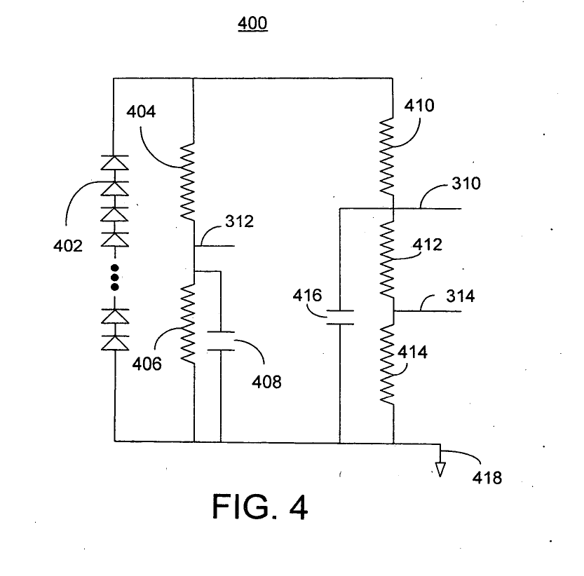

FIG. 4 shows a circuit 400, which is an embodiment of part of circuit 300. FIG. 4 includes upper limit signal 310, CT signal 312, lower limit signal 314, series of photodiodes 402, resistor 404, resistor 406, capacitor 408, resistor 410, resistor 412, resistor 414, capacitor 416, and reference 418. In other embodiments, circuit 400 may not include all of the components listed above or may include other components instead of and/or in addition to those listed above.

Series of photodiodes 402 are one embodiment of photocells 302. Resistors 402 and 404 divide the total voltage output of series of photodiodes 402, and determine the voltage level of CT signal 312. If the current of CT signal 312 is kept relatively small compared to the current flowing through resistors 404 and 406, then the voltage level of CT signal 312 is a fraction of the total voltage of series of photodiodes 402, which is approximately determined by the fraction

$${f}_{CT} = \frac{( resistor 406 )}{( resistor 404 ) + ( resistor 406 )} .$$

Capacitor 408 forms a filter with resistor 404 and resistor 406. Capacitor 408 is associated with a relaxation constant τ₄₀₈ is given by

$${τ}_{408} = \frac{( capacitor 408 ) ( resistor 404 ) ( resistor 406 )}{( resistor 404 ) + ( resistor 406 )} .$$

Relaxation constant τ₄₀₈ determines the time over which the CT signal 312 is averaged. The relaxation constant should be small enough so that CT signal 312 changes significantly in response to moving a hand or a finger over series of photodiodes 402. However, capacitor 408, resistor 404, and resistor 406 should form a relaxation constant that is also long enough to average noise that is of a higher frequency. In an embodiment, the relaxation constant is several hundred microseconds. If sufficient light is blocked (or produced), CT signal 312 will become less than (or greater than) both limits. In other words, the product of the capacitance of capacitor 408 and the equivalent resistance

$$\frac{( resistor 404 ) ( resistor 406 )}{( resistor 404 ) + ( resistor 406 )}$$

(formed by resistors 406 and 408) should be of an appropriate value for creating a relaxation constant such that CT signal 312 is sensitive to a wave of a hand and/or finger, but insensitive to higher frequency noise.

Similarly, resistors 410, 412, and 414 divide the total voltage output of series of photodiodes 402, and determine the voltage levels of upper limit signal 310 and lower limit signal 314. If the current of upper limit signal 310 and lower limit signal 314 are both kept relatively small compared to the current flowing through resistors 410, 412 and 414, then the voltage level of lower limit signal 310 is a fraction of the total voltage of series of photodiodes 402, which is approximately determined by the fraction

$${f}_{UL} = \frac{( resistor 412 ) + ( resistor 414 )}{( resistor 410 ) + ( resistor 412 ) + ( resistor 414 )} .$$

Also, if the current of upper limit signal 310 and lower limit signal 314 are both kept relatively small compared to the current flowing through resistors 410, 412 and 414, then the voltage level of lower limit signal 314 is a fraction of the total voltage of series of photodiodes 402, which is approximately determined by the fraction

$${f}_{LL} = \frac{( resistor 414 )}{( resistor 410 ) + ( resistor 412 ) + ( resistor 414 )} .$$

Accordingly, the ratio of the values of resistor 404, 406, 410, 412, and 414 may be chosen such that when there is no information being input via series of photodiodes 402 (e.g., during a period in which the light does not change) the voltage level of CT signal 312 is between the voltage levels for upper limit signal 310 and lower limit signal 314. For example, the resistances of resistors 404, 406, 410, 412, and 414 may be chosen such that
f_{LL}<f_{CT}<f_{UL}.

Resistor 410 is optional. In one embodiment, let the letter R represent any value between 100 KΩ and 2 GΩ. Then the value of resistor 404, 406, 410, and 414 may be R, and the value of resistor 412 may be 0.1 R. Alternatively, the value of resistor 404 may be 0.05 R, the value of resistors 406 and 414 may be R, resistor 410 may be 0Ω (in other words resistor 410 may be left out of the circuit), and the value of resistor 412 can be 0.1 R. A larger range of resistances could also be used depending on the maximum current and voltage output of photocells 402.

In another embodiment, the value of resistor 404 may be chosen to be equal to or substantially equal to resistor 406 (e.g., have the same nominal values when sold or have values that are within, or essentially within, +/−1%, 5%, 10%, or 20% of one another). Choosing resistor 410 and 412 to have essentially equal values, results in CT signal 312 being essentially half the voltage of series of photodiodes 402. Also, choosing the values of resistors 410, 412 and 414 to be equal, or substantially equal, results in the voltage of the upper limit signal 310 being essentially two thirds of the voltage of series of photodiodes 402 and the voltage of the lower limit signal 314 being essentially one third the voltage of series of photodiodes 402.

In an embodiment, the sum of the values of resistors 404 and 406 is chosen to be equal, or substantially equal, to the sum of the values of resistors 410, 412 and 418. In an embodiment, the values of resistors 404, 406, 410, 412 and 418 are all chosen to be equal or substantially equal to one another. In an embodiment, the resistance of resistors 404, 406, 410, 412, and 418 are chosen to each be greater than 2 GΩ.

Capacitor 416 forms a filter with resistors 410, 412, and 414. If the current of upper limit signal 310 and lower limit signal 314 are both kept relatively small compared to the current flowing through resistors 410, 412 and 414, then a relaxation constant τ₄₁₆ associated with capacitor 416 is given by

$${τ}_{416} = \frac{( capacitor 416 ) ( resistor 410 ) [ ( resistor 412 ) + ( resistor 414 ) ]}{( resistor 410 ) + ( resistor 412 ) + ( resistor 414 )} .$$

The relaxation constant τ₄₁₆ determines the time over which upper limit signal 310 and lower limit signal 314 are averaged. The relaxation constant should be large enough (e.g., several seconds) so that upper limit signal 310 and lower limit signal 314 do not change significantly in response to moving a hand or a finger over series of photodiodes 402. Consequently the product of the capacitance of capacitor 416 and the sum of the resistances of resistors 412 and 414 should be of appropriate values for creating a relaxation such that upper limit signal 310 and lower limit signal 314 are not sensitive to a wave of a hand, a finger, other body part, and/or other object. In an embodiment, capacitor 416 has a capacitance that is ten times that of capacitor 408. The components of circuit 400 are passive, and consequently the resulting power consumption is relatively low.

The capacitance of capacitor 416 may be selected such that relaxation constant τ₄₁₆ is between 0.5 milliseconds and 2 milliseconds. Thus, if resistor 406 is R, resistor 410 is R, resistor 412 is 0.1 R, and resistor 414 is R, then the relaxation time associated with capacitor 416 will be between 0.5 and 2 milliseconds, and the relaxation time associated with capacitor 408 will be between 0.2 and 0.05 milliseconds. Consequently, the signal from the center tap 312 will be time averaged over between 0.05 and 0.2 milliseconds, and the signal from upper limit 310 and lower limit 314 will be time averaged over a period of at least between 0.5 and 2 milliseconds (e.g., between 0.55 and 2.2 milliseconds). Smaller resistances and larger capacitors than those listed above could also be used. However, larger capacitors also require more space, and the capacitor should not be so large as to make timepiece 100 undesirably bulky or have an undesirable shape. The tolerance on the values of the resistors 404, 406, 410, 412, and 414 and of the capacitors 408 and 416 in some embodiments is +/−20% or less (e.g., +/−1%, 5%, 10%).

In an embodiment, timepiece 100 may include at least two circuit 400s—at least one circuit 400 having resistor 404, resistor 406, and/or capacitor 408 chosen to accept signals that are of a frequency generated by waving a hand and at least one circuit 400 having resistor 404, resistor 406, and/or capacitor 408 chosen to accept signals that are of a frequency generated by a remote control, which (for example) may generate signals of a significantly greater frequency than the signals generated by a hand.

If the current of CT signal 312 is not kept relatively small, then, denoting the load driven by CT signal 312 as LCT (ignoring the complexities of the circuit driven by CT signal 312 and assuming that LCT can be treated as a resistance), the relaxation time τ₄₀₈ becomes

$${τ}_{408} = \frac{( capacitor 408 ) LCT ( resistor 404 ) ( resistor 406 )}{\begin{matrix}LCT ( resistor 404 ) + LCT ( resistor 406 ) + \\ ( resistor 404 ) ( resistor 406 )\end{matrix}} .$$

In the above discussion about the manner in which the voltage is divided, if the current used by CT 312 is not small, assuming that LCT is referenced to ground, and assuming that LCT can be treated as a resistance, the resistance of resistor 406 is replaced by an effective resistance, which is approximately given by

$$R\_Effect \_LCT = \frac{( resistor 406 ) LCT}{( resistor 406 ) + LCT} .$$

Similarly, if the currents of upper limit signal 310 and lower limit signal 314 are not kept relatively small, then, denoting the load driven lower limit signal 314 as LL (ignoring the complexities of the circuit driven by lower limit signal 314, assuming that LL is referenced to ground, and assuming that LL can be treated as a resistance), in the above fraction the resistance of resistor 414 is replaced by an effective resistance, which is approximately given by

$$R\_Effect \_LL = \frac{( resistor 414 ) LL}{( resistor 414 ) + LL} .$$

Additionally, if the currents of upper limit signal 310 and lower limit signal 314 are not kept relatively small, then, denoting the load driven by upper limit signal 310 as LU (ignoring the complexities of the circuit driven by upper limit signal 310, assuming that LU is referenced to ground, and assuming that LU can be treated as a resistance), in the above discussion of the manner in which the voltage is divided the sum of the resistances (resistor 412)+(resistor 414) is replaced by an effective resistance, which is approximately given by

$$R\_Effect \_LU = \frac{[ ( resistor 412 ) + ( R\_Effect \_LL ) ] LU}{( resistor 412 ) + ( R\_Effect \_LL ) + LU} .$$

Consequently f_{LL} becomes

$${f}_{LL} = \frac{( R\_Effect \_LL ) ( R\_Effect \_LU )}{[ ( resistor 410 ) + ( R\_Effect \_LU ) ] ( R\_sum )} , where$$

$$R\_sum = ( resistor 412 ) + ( R\_Effect \_LL ) .$$

Similarly, f_{UL} becomes

$${f}_{UL} = \frac{( R\_Effect \_LU )}{( resistor 410 ) + ( R\_Effect \_LU )} .$$

As a result of the current loss at upper limit 310, the voltage is reduced across resistors 412 and 414, thereby reducing f_{LL} by a multiplicative factor.

Additionally, relaxation time τ₄₁₆ becomes

$${τ}_{416} = \frac{( capacitor 416 ) ( resistor 410 ) LU ( R\_sum )}{( resistor 410 ) LU + ( R\_sum ) LU + ( resistor 410 ) R\_sum}$$

(ignoring the complexities of the circuit driven by lower limit signal 314, assuming that LU is referenced to ground, and assuming that LU can be treated as a resistance). If LU and/or LL are not referenced to ground and/or cannot be approximated as resistances, the formulas for τ₄₀₈, τ₄₁₆, f_{UL}, and f_{LL} may be considerably different than the formulas above, but can be derived from circuit equations or by taking account of the effect of the transfer functions for LU and LL when computing τ₄₀₈, τ₄₁₆, f_{UL}, and f_{LL}.

Reference 418 could be a reference to ground, and prevents the voltage level of circuit 400 from floating. In an embodiment, many photodiodes are included for the sake of providing redundancy. Two or more circuits 400 are incorporated within timepiece 100. Thus if one of circuits 400 fails, there is at least one more that circuits 400 that will still perform the data input functions. In an embodiment, six photodiodes are used for each of circuit 400. Redundancy allows the timepiece 100 to function even if a component fails. With two complete circuits 400 available, reliability is dramatically improved. For example, if one circuit 400 experiences failure probability of 1% per 50,000 hours, two circuits together will only have a failure probability of 0.01% per 50,000 hours.

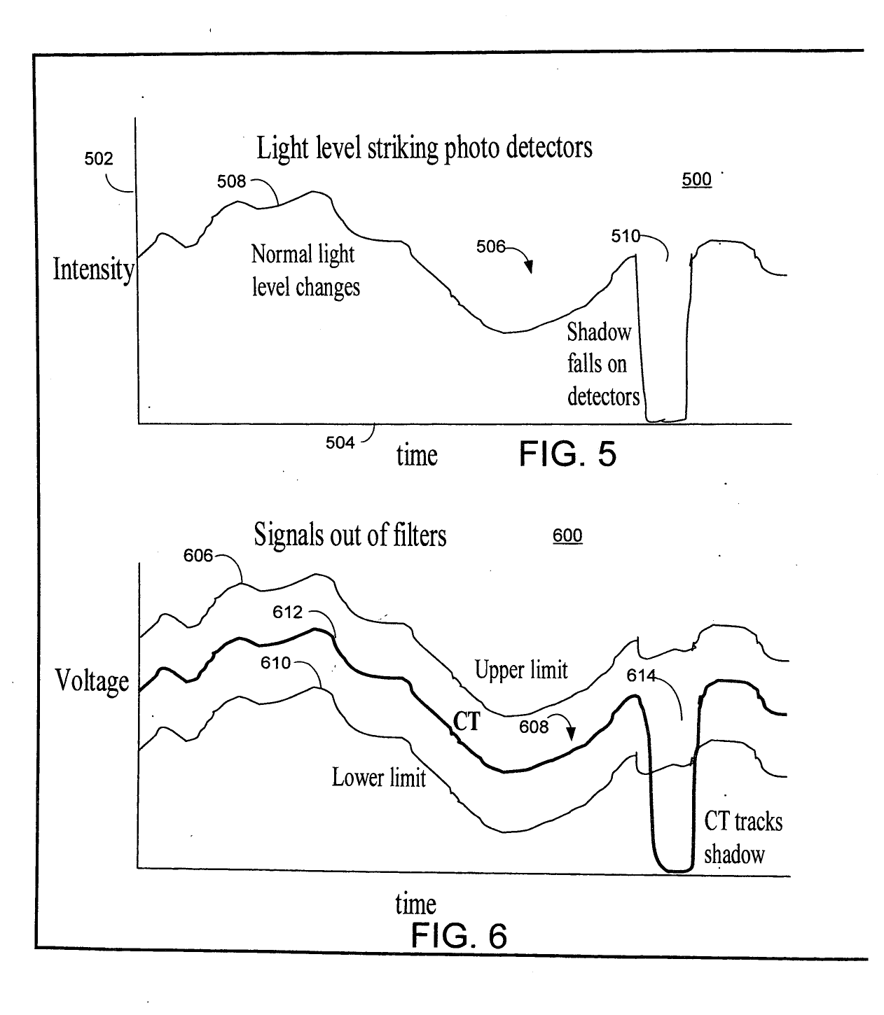

FIG. 5 is a graph 500 of light intensity verses time. Graph 500 has an axis 502, labeled intensity, and an axis 504, labeled time. Graph 500 includes plot 506, which has two parts, which are normal part 508 and shadow part 510. In other embodiments, timepiece 100 may not respond to the variation of light of plot 506 and/or may respond to other types of variations of light.

Plot 506 is a plot of a variation in light intensity experienced by timepiece 100 (FIG. 1). If timepiece 100 is a watch, the normal variation in light may be significant while the wearer of timepiece 100 is moving from place to place and/or is moving his or her arms while performing normal activities. The normal changes in light are represented by normal part 508, which occur relatively slowly over time. Shadow part 510 represents the change in the light level when a shadow is intentionally created by waving a hand, for example, over photosensor 102 (FIG. 1). The drop in the light intensity, represented by shadow part 510, occurs over a much shorter time period and to a greater extent than the changes in light that occur as a result of normal activities.

FIG. 6 is a graph 600 of voltage verses time caused by the changes in light intensity plotted in FIG. 5. Graph 600 has an axis 602, labeled voltage, and an axis 604, labeled time. Graph 600 includes three plots of voltage verses time, which are plots 606, 608, and 610. Plot 608 includes normal part 612 and shadow part 614. In other embodiments, time piece 100 may not be capable of all of the voltage responses shown in graph 600, or may be capable of other voltage responses instead of and/or in addition to those listed above.

Plots 606, 608, and 610 are plots of upper limit signal 310, CT signal 312, and lower limit signal 314, respectively, when subjected to the variations in light plotted in FIG. 5, represented by plot 506. FIG. 6 shows the behavior of upper limit signal 310, CT signal 312, and lower limit signal 314 in response to the light variations from the shadow represented by shadow part 510. Normally while the watch is moving and the light level is changing gradually as represented by normal part 508, all three signals (upper limit signal 310, CT signal 312, and lower limit signal 314) move in unison so that CT signal 312 stays centered or at least between upper limit signal 310 and lower limit signal 314. When a shadow falls on photosensor 102, upper limit signal 310 and lower limit signal 314 experience a relatively small change in voltage, because upper limit signal 310 and lower limit signal 314 are filtered with the long time constants associated with capacitor 416. In contrast, the change in the voltage level of CT signal 312 is relatively large and tends to mimic the variation in light intensity. In plot 612, enough light has been blocked to cause CT signal 312 to transition below the lower limit signal 314, which is detected by limit sense 316 (FIG. 3), causing output signal 318 to indicate the crossing of the lower threshold to the logic part of electronics and motion mechanism 122.

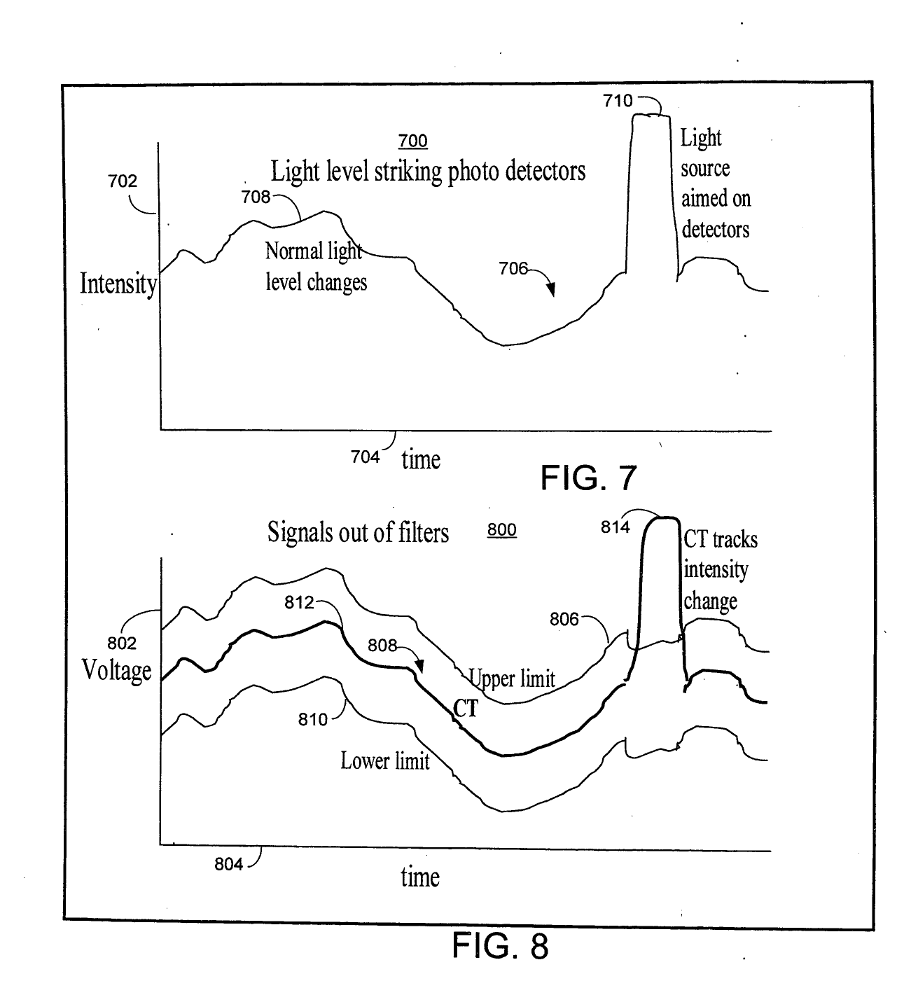

FIG. 7 is a graph 700 of light intensity verses time. Graph 700 has an axis 702, labeled intensity, and an axis 704, labeled time. Graph 700 includes a plot 706. Plot 706 has two parts, which are normal part 708 and light part 710. In other embodiments, timepiece 100 may not respond to the variation of light of plot 706 and/or may respond to other types of variations of light.

Plot 706 represents changes in light intensity with time. Normal part 708 represents the changes in light intensity due to normal activities, similar to normal part 508 (FIG. 5). In contrast to shadow part 510, light part 710 represents the change in the light level when a light is intentionally shined on photosensor 102 (FIG. 1). The rise in the light intensity, represented by light part 510, occurs over a much shorter time period and to a greater extent than the changes in light that occur as a result of normal activities.

FIG. 8 is a graph 800 of voltage verses time caused by the variation in light intensity plotted in FIG. 7. Graph 800 has an axis 802, labeled voltage, and an axis 804, labeled time. Graph 800 includes three plots of voltage verses time, which are plots 806, 808, and 810. Plot 808 includes normal part 812 and light part 814. In other embodiments, time piece 100 may not be capable of all of the voltage responses shown in graph 800, or may be capable of other voltage responses instead of and/or in addition to those listed above.

Similar to the explanation of FIG. 6, plots 806, 808, and 810 are plots of upper limit signal 310, CT signal 312, and lower limit signal 314, respectively, when subjected to the variations in light plotted in FIG. 7, represented by plot 706. FIG. 8 shows the behavior of upper limit signal 310, CT signal 312, and lower limit signal 314 in response to the light variations from the light represented by light part 710. Normal part 808 represents the change in the voltage level of CT signal 312 during normal lighting conditions, during which all three signals (upper limit signal 310, CT signal 312, and lower limit signal 314) move in unison so that CT signal 312 stays centered or at least between upper limit signal 310 and lower limit signal 314. When light is shined on the photosensor 102, upper limit signal 310 and lower limit signal 314 experience a relatively small change in voltage, because upper limit signal 310 and lower limit signal 314 are filtered with the long time constants associated with capacitor 416, resistor 410, resistor 412, and resistor 414. In contrast, the change in the voltage level of CT signal 312 is relatively large and tends to mimic the variation in light intensity. In graph 800, the light is bright enough to cause CT signal 312 to transition above the upper limit signal 314, which is detected by limit sense 316 (FIG. 3), causing output signal 318 to indicate the crossing of the upper threshold to the logic part of electronics and motion mechanism 122.

Circuits 300 and 400 (FIGS. 3 and 4) may also be used for sensing changes in light level in other environments unrelated to timepiece 100 (FIG. 1). For example, circuits 300 and 400 may be used for inputting information for changing channels on televisions, turning on and off lights, opening doors, and/or programming timers.

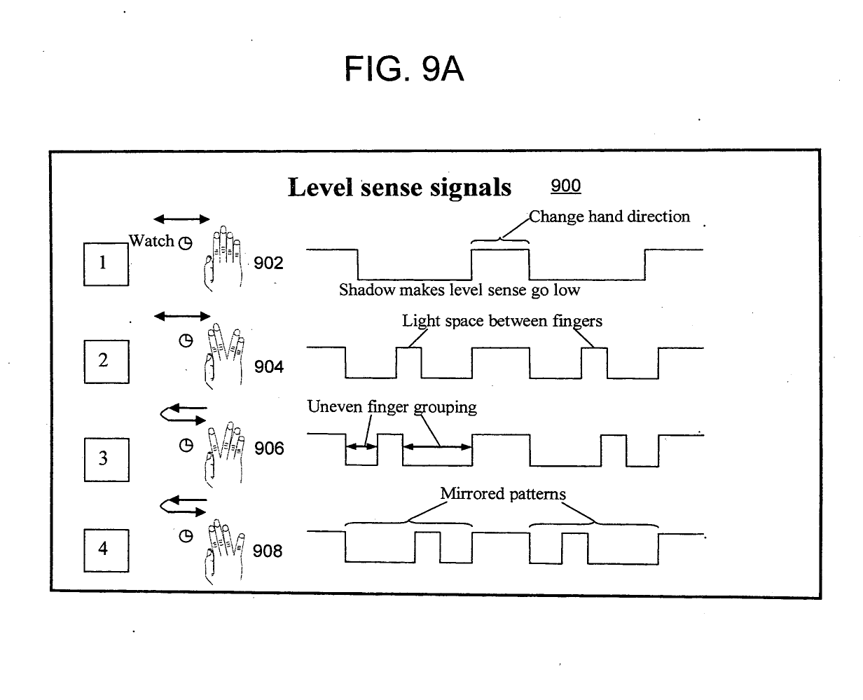

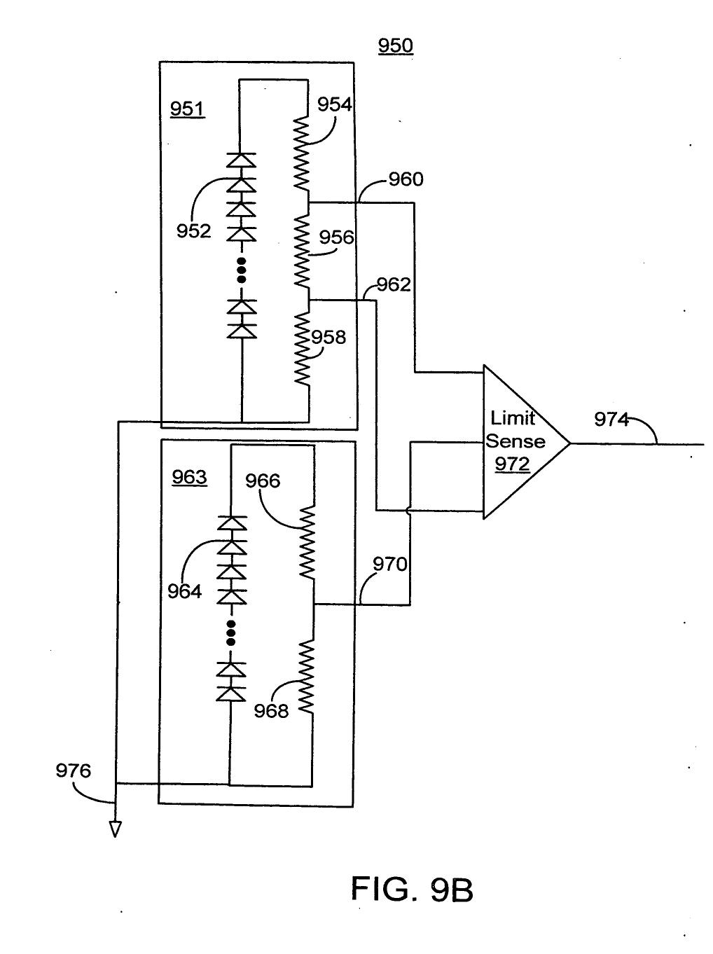

FIG. 9A shows an illustration 900 of some methods of inputting information via photosensor 102. Illustration 900 includes hand inputs 902, 904, 906, and 908 and corresponding wave forms 912, 914, 916, and 918. In other embodiments, timepiece 100 may not accept all of the inputs listed above or may accept other inputs instead of and/or in addition to those listed above.

Although circuits 300 and 400 reject low frequency light level changes and high frequency noise, it is still possible for an occasional shadow or burst of light to cause CT signal 312 to cross one of the two thresholds. Some examples of events that may cause CT signal 312 to cross one of the thresholds are turning on a lamp, pulling up or rolling down a sleeve covering the timepiece 100, or the swinging the arm that wears timepiece 100 through a region having a shadow portion and a brighter portion. To reduce the likelihood of such events being mistaken for intentional input, timepiece 100 may be configured to only respond to specific patterns of input. For example, timepiece 100 may be configured to reject input that is not one of a specific set of patterns or alternatively to reject signals that are not of certain types of patterns. In an embodiment these temporal filters are accomplished by requiring the user to hold a hand in specific configurations and move the hand over timepiece 100 back and forth to create input patterns of light (which may be referred to as hand inputs). FIG. 9A illustrates some examples of input patterns that timepiece 100 may be configured to accept.

In an embodiment, the user may be required to separate some of fingers before passing them over the timepiece 100. Different separations of fingers create differently phased patterns. Hand inputs 902, 904, 906, and 908 produce voltage signals represented by wave forms 912, 914, 916, and 918, respectively. In each of hand inputs 902, 904, 906, and 908 a hand is waved back and forth over photosensor 102. The back motion associated with hand inputs 902, 904, 906, and 908 produces a first part of wave forms 912, 914, 916, and 918, respectively, and the forward motion associated with hand inputs 902, 904, 906, and 908 produces a second part of wave forms 912, 914, 916, and 918, respectively. Hand input 902 has no spaces between fingers, and wave form 912 has two long corresponding shadow inputs or dips in CT signal 312. Hand input 904 has a space in the middle of the four fingers, and wave form 912 has for shorter shadow inputs or dips in CT signal 312. The two parts of wave form 912 are essentially the same as one another, because the widths of the shadows cast by the two groupings of fingers are roughly the same.

Hand inputs 906 and 908 each have three fingers grouped together and a fourth finger by itself. Hand inputs 906 and 908 differ by which finger is set apart from the other three. Specifically in hand input 906 the index finger is kept separate from the other fingers generating a temporally short dip followed by a temporally long dip in the first half of wave form 916, while in hand input 908, the pinky is kept separate from the other fingers generating a temporally long dip followed by a temporally short dip in the first half of wave form 918. The two portions of wave forms 916 are essentially mirror images of one another, because by making the back and forth motion with the hand causes which ever part of the pattern that was input first in the back motion to be input last in the forward motion. Similarly, the two portions of each of wave forms 918 are essentially mirror images of one another for the same reason as explained in conjunction with wave form 916.

A shadow of consistent duration and pattern can be created by moving a hand in a consistent manner over timepiece 100. In an embodiment, the watch logic within electronics and motion mechanism 122 is configured to recognize the consistent pattern associated with moving a hand consistently back and forth over timepiece 100 to create a shadow of consistent duration. Anything else that produces a signal does not necessarily produce a signal with the required timing and is thus rejected. In an embodiment, timepiece 100 is configured to require the back and forth motion of the hand, and to use the reverse pattern of the second half of the wave form (generated by moving the hand in the reverse direction) as verification that the pattern is intended to be input. In an embodiment, timepiece 100 may have a setup mode that includes calibrating the timepiece 100 to a particular user. During this calibration process, timepiece 100 reads input generated by repeatedly passing the user's hand back and forth over the watch until it calibrates itself for the timing of that user.

The four hand inputs illustrated are just examples of hand inputs, but many others may be used. For example, waving the hand while keeping all four fingers spread or while keeping only two of the fingers grouped together could be other inputs.

FIG. 9B shows a block diagram of an example of a circuit 950 for detecting phase modulated input signals. Circuit 950 includes photo-voltage source 951, which may include photo photocells 952, resistor 954, resistor 956, resistor 958, upper limit signal 960, and lower limit signal 962. Circuit 950 also includes photo-voltage source 963, which may include photo photocells 964, resistor 966, resistor 968, and CT signal 970. Circuit 950 further includes limit sense 972, output 974, and reference 976. In other embodiments, circuit 950 may not include all of the components listed above or may include other components instead of and/or in addition to those listed above.

Circuit 950 may be used to input phase modulated signals, which may be used for inputting information into timepiece 100. Similar to circuits 300 or 400, photo-voltage source 951 produces upper limit signal 960 and lower limit signal 962. In an embodiment, the manner in which upper limit signal 960 and lower limit signal 962 are produced is photocells 952 produce a voltage, which is divided by resistors 954 and 956, and optionally by resistor 958. In an embodiment, resistors 954 and 956, and optionally resistor 958 are chosen such that the upper limit signal 960 is greater than lower limit signal 962, and center tap signal 970 is a voltage level that is between upper limit signal 960 and lower limit signal 962 when both sides of timepiece 100 are illuminated with the same amount of, or essentially the same amount of, light. In an embodiment, photocells 952 are photodiodes.

Similarly, photo-voltage source 963 produces CT signal 970. In an embodiment, similar to circuits 300 or 400, the manner in which upper limit signal 970 is produced is photocells 954 produce a voltage, which is divided by resistors 962, and 964. In an embodiment, resistors 962 and 964 are equal such that the CT signal 970 is approximately one half of the voltage across photocells 954, assuming that the load being driven by CT signal 970 is relatively small.

Similar to the resistors in circuits 300 and 400, the same range of values (e.g., satisfying the same equations) that are usable for resistors 404, 406, 410, 412, and 414 (FIG. 4) may be used for resistors 966, 968, 954, 956, and 958, respectively. Resistor 958 is optional.

Limit sense 972 detects when CT signal 970 crosses upper limit signal 960 or lower limit signal 962. Limit sense 972 may be the same as limit sense 316 (FIG. 3). Output 974 is produced by limit sense 972 and sent to electronics and motion mechanism 122 (FIG. 1). Reference 976 could be a ground. Reference 976 ensures that the voltages from photocells 952 and 964 do not float with respect to one another so that the comparison of the voltage outputs of photocells 952 and 964 represents a difference in lighting and not a difference in reference voltages.

In contrast to the photocells of circuits 300 and 400, photocells 952 and 963 are located in different locations on the face of timepiece 100. When the light that is incident on photo-voltage sources 951 and 963 is of the same intensity, CT signal 970 is between upper limit signal 960 and lower limit signal 962. When significantly more light is incident on photo-voltage source 963 than on photo-voltage source 951, CT signal 970 crosses above upper limit signal 960. When significantly less light is incident on photo-voltage source 963 than on photo-voltage source 951, CT signal 970 crosses below lower limit signal 962. Consequently, circuit 950 indicates when one side of time piece 100 is receiving more light than the other side. Thus, when a hand is waved over circuit 950, circuit 950 may indicate the direction in which the hand is traveling. Photo-voltage sources 951 and 963 may be constructed in other manners than the specific embodiments depicted in FIG. 9B.

Thus, circuit 950 is similar to circuit 300 (FIG. 3) and circuit 400 (FIG. 4) in that circuit 950 and circuit 400 both have two voltage dividers, and circuits 950, 300 and 400 all produce upper limit signals, CT, signals, and lower limit signals. However, circuit 950 indicates when there is a difference in light intensity between different locations on face time piece 100. The embodiment of circuit 950 may use a signal differencing or phase sensitive techniques (rather than amplitude sensitive techniques) to encode shadows and reject ambient noise is illustrated.

In the embodiment of circuit 950, the filters are not necessary, because all three levels change together as ambient light changes ensuring that all three levels remain registered with each other. Optionally, filters may nonetheless be included. In one embodiment in which filters are included, the time constant associated with the filter for CT signal 970 should be substantially the same as the time constant associated with upper limit signal 960 and lower limit signal 962 so that CT signal 970, upper limit signal 960, and lower limit signal 962 track one another when the lighting across the face of time piece 100 is uniform. In another embodiment in which filters are included, the time constant associated with the filter for CT signal 970 is substantially different from the time constant associated with upper limit signal 960 and lower limit signal 962 so that CT signal 970 crosses upper limit signal 960 or lower limit signal 962 when either the lighting across the face of time piece 100 is not uniform or when the lighting on the face changes briefly from that of the ambient lighting.

Since CT signal 970 is between upper limit signal 960 and lower limit signal 962, circuit 950 will detect whether a shadow is place across only part of the face of time piece 100 or whether a light is shined on only part of the face of time piece 100. Circuit 950 may be used instead of or in addition to circuit 300 and/or 400. In the embodiment of circuit 950, electronics and motion mechanism 122 (FIG. 1) includes logic for interpreting the timing between signal changes to determine what command has been requested by the user instead of or in addition to logic for interpreting changes in amplitude.

Similar to circuits 300 and 400 circuit 950 may be used for other purposes other than just entering information into timepiece 100. For example, circuit 950 may be used for any of the applications, discussed above, for which circuits 300 and 400 may be used.

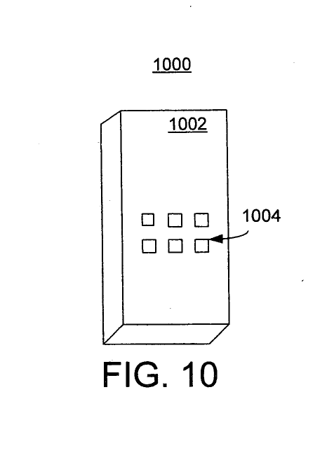

FIG. 10 shows a representation of a remote control 1000. Remote control 1000 may include housing 1002 and control buttons 1004. In other embodiments, remote control 1000 may not include all of the components listed above or may include other components instead of and/or in addition to those listed above.

Remote control 1000 generates signals for that are sent to timepiece 100 for setting and/or inputting other information. Remote control 1000 may send light signals of any of a number of frequencies. In an embodiment, remote control 1000 sends light in the near infrared range. In another embodiment, remote control 1000 sends sound signals, such as ultrasound and/or other sound signals. Housing 1002 houses the circuitry and/or mechanism that generates and sends the signals. Control buttons 1004 are used for determining the signals to send. The user presses buttons from remote control 1004 to choose whether to set the time, date, or other information, and to enter the time date and/or other information. Control buttons 1004 may interact with a modulator that modulates a signal that is then sent to a transmitter, such as a light source or source of sound, which transmits the signals to timepiece 100. The modulator and transmitter are located within remote control 1000. The patterns of light sent from remote control 1000 may be similar to patterns of light generated by waving a hand, which were described in conjunction with FIG. 9A, for example. Alternatively, there may be variety of other signals that are sent from remote control 1000 to timepiece 100 in addition to or instead of the patterns associated with FIG. 9A. Logic part of electronics and motion mechanism 122 may decode the light signals from remote control 1000 in a similar fashion the hand signals are decoded. Although FIG. 10 only illustrates six buttons within control buttons 1004, control buttons may include any number of buttons.

FIG. 11 shows an example of a face 1100, which may be included within timepiece 100. Face 1100 includes large dot 1102, orbs 1104, 1106, and 1108, bezel 1109, philosophical messages 1110, 1112, and 1114, and dots 1116a−1. In other embodiments, face 1100 may not include all of the components listed above or may include other components instead of and/or in addition to those listed above.

Large dot 1102 is optional. Large dot 1102 may be painted yellow or another color that represents the Sun. In another embodiment, large dot 1102 is painted another color, such as purple, blue, green, or any other color or any combination of colors. In an embodiment, large dot 1102 may be an orb or a portion of a sphere. Orbs 1104, 1106, and 1108 are an embodiment of orbs 112, 108, and 104 (FIG. 1), respectively. In an embodiment in which timepiece 100 is large enough so that orbs 1104, 1106, and/or 1108 are still visible, the ratio of the size of large dot 1102 to orbs 1104, 1106, and/or 1108 may be essentially the same as the ratio of size of the Sun to the planets each of orbs 1104, 1106, and 1108 represent. For example, this embodiment of timepiece 100 could be placed in a museum, and in this embodiment, timepiece 100 may be several hundred feet in diameter. Bezel 1109 is an embodiment of bezel 130. Bezel 1109 may be blue or any other color. Philosophical messages 1110, 1112, and 1114 may be “IT IS NOW,” “I AM HERE,” and “NOW IS FOREVER,” respectively. Philosophical messages 1110 and 1112 may be black or blue or any other color. The background of philosophical messages 1110 and 1112 may be granite in appearance, grey, white, or any other color.

Dots 1116a−1 mark the hour positions on timepiece 100. Dots 1116a−1 are located just inside of bezel 1109. In an embodiment, timepiece 100 is a purely mechanical timepiece that is powered by winding up a spring. In another embodiment, orbs 1104, 1106, and 1108 are propelled by an electromechanical motor without any photosensors. Optionally, in the embodiment in which orbs 1104, 1106, and 1108 are propelled by an electromechanical motor, dots 1116a−1 include photocells for powering timepiece 100 and/or for entering information such as the current time. Dots 1116a−1 may each include one or more photocells, such as photocells 302 (FIG. 3). In an embodiment, phase modulated signals may be detected by measuring the difference in the lighting at different positions on the face of timepiece 100 using dots 1116a−1 and/or by measuring the time periods over which these differences in lighting occur. In an embodiment, shadow patterns that are input by the hand are interpreted differently depending upon which one and/or combination of dots 1116a−1 are covered. In an embodiment, dots 1116a−1 form decorative locations where photocells may be placed or camouflaged.

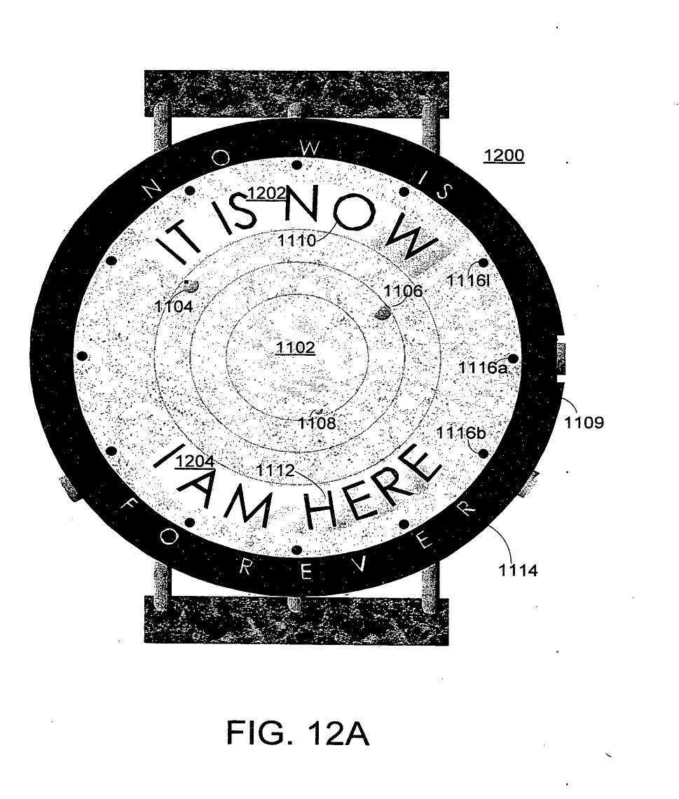

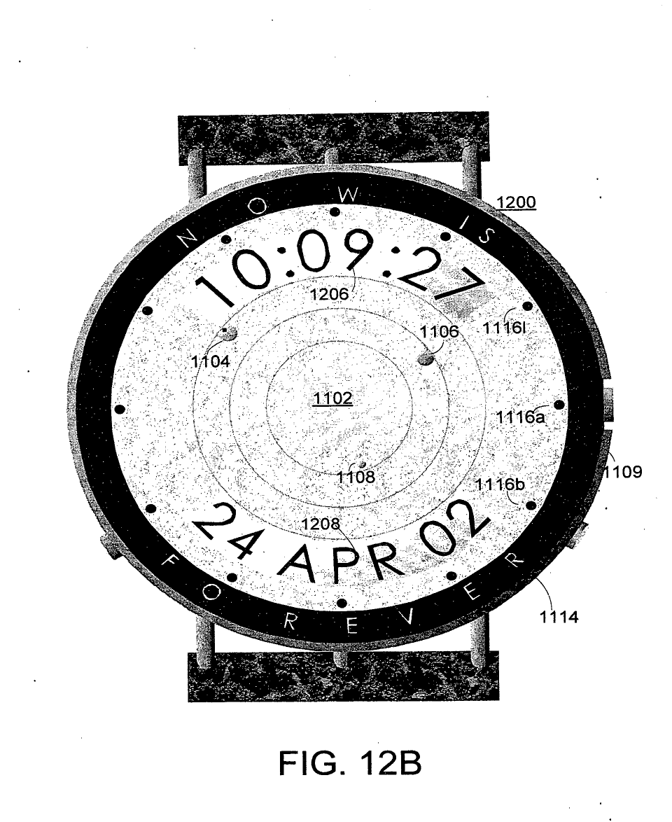

FIGS. 12A and 12B show an example of a face 1200, which may be included within timepiece 100. Face 1200 includes large dot 1102, orbs 1104, 1106, and 1108, bezel 1109, philosophical messages 1110, 1112, and 1114, dots 1116a−1, and message areas 1202 and 1204. Message areas 1202 and 1206 display philosophical messages 1110 and 1112 (FIG. 12A) or time 1206 and date 1208 (FIG. 12B). In other embodiments, face 1200 may not include all of the components listed above or may include other components instead of and/or in addition to those listed above.

Large dot 1102, orbs 1104, 1106, and 1108, bezel 1109, philosophical messages 1110, 1112, and 1114, and dots 1116a−1 are discussed in conjunction with FIG. 11. Face 1200 differs from face 1100 in that face 1200 has message areas 1202 and 1204. Message areas 1202 and 1204 may be display cells and are embodiments of display 118 (FIG. 1). In the embodiment of timepiece 100 having display 1200, message areas 1202 and 1204 may display different messages, such as philosophical messages 1110 and 1112, time 1206, and date 1208. Timepiece 100 may have different modes that display different combinations of philosophical messages 1110 and 1112, time 1206 and date 1208. For example, one mode may display philosophical messages 1110 and 1112, one mode may display time 1206 and date 1208, one mode may display message 1110 and date 1208, and one mode may display message 1112 and time 1206.

In an embodiment, timepiece 100 may function in a mode in which messages 1110 and 1112 are displayed unless the user requests timepiece 100 to display time 1206 and/or date 1208. In an embodiment, during a procedure for setting the time and/or date, timepiece 100 initially displays philosophical messages 1110 and 1112 until information is entered for setting the time and/or date. If a time out occurs as a result of the user not entering any input for a period of time greater than a predetermined duration, timepiece 100 reverts to displaying philosophical messages 1110 and/or 1112. In one embodiment of timepiece 100 having face 1200, orbs 1104, 1106, and 1108 are not used to convey the time, but instead orbit at a rate that is either the same as, or proportional to, the rate of the orbits of the planets that orbs 1104, 1106, and 1108 represent.

In FIGS. 11, 12A, and 12B, the combination of philosophical messages 1110, 1112, and 1114 and the dot on orb 1104 may remind the user to appreciate the present time and place wherever the user is, whatever time it is, and wherever the user is going. The philosophical message 1110 and 1114 may each individually remind the user to live and appreciate the present moment, while the dot on orb 1104 and philosophical message 1112 may each individually remind the user to appreciate the user's present location.

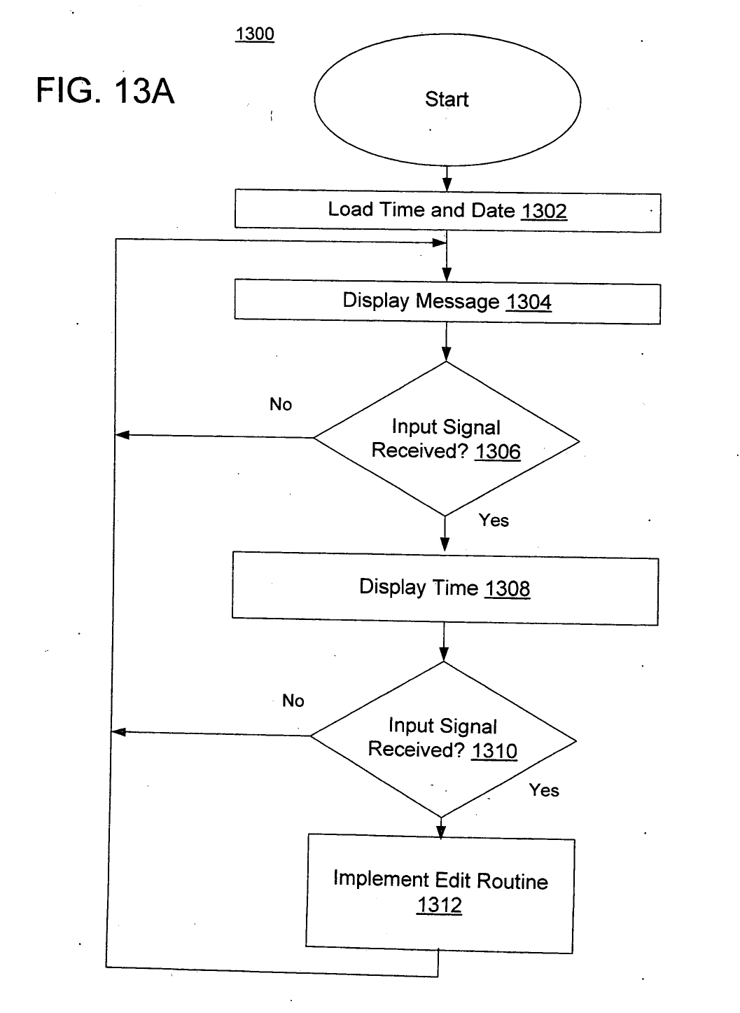

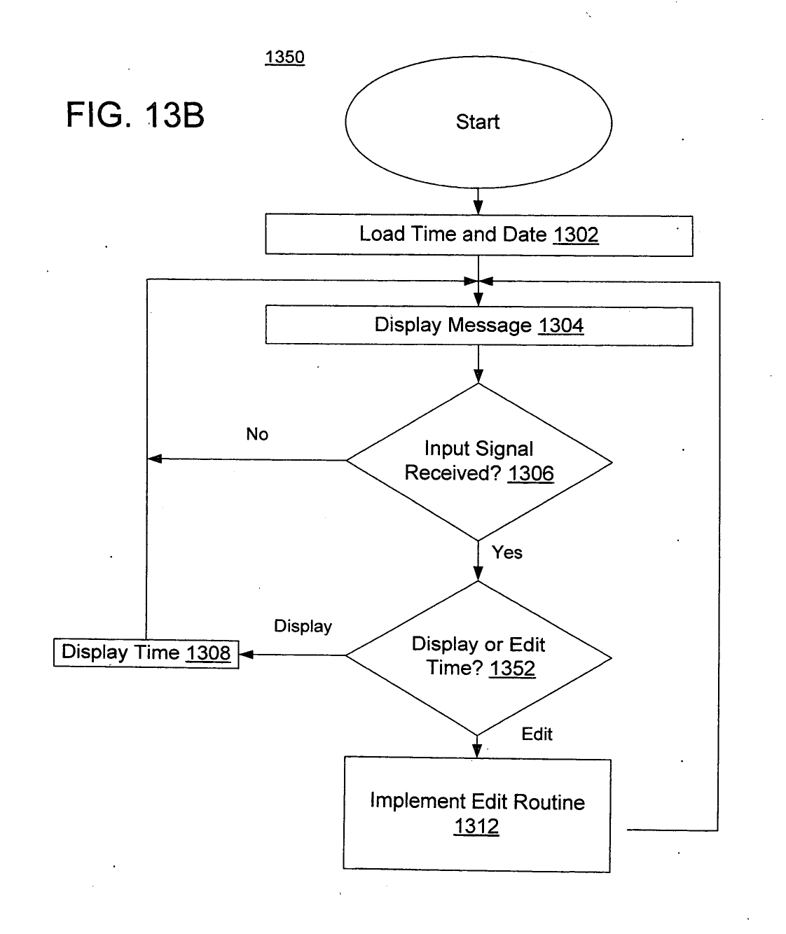

FIG. 13A shows a flowchart of an example of a method 1300 for setting timepiece 100. FIG. 13A is an example of a flowchart of internal logic for editing display 118 and for determining a message to display. In method 1300, a user input interacts with timepiece 100 allowing the user to sequence through various operations. In an embodiment, method 1300 runs from the time the battery is installed until the battery is replaced. In step 1302, the time and date or a default time and date are loaded into timepiece 100. In an embodiment, a current time and/or date may be automatically retrieved from a remote source, such as an atomic clock or radio transmitter. In step 1304, one or more philosophical messages are displayed in message areas 1202 and 1204 (FIG. 12A). In step 1306, method 1300 waits for user input. When user input is received, the time is displayed in step 1308. If after a predetermined period of time no user input is received, method 1300 returns to step 1304. In step 1310, timepiece 100 again waits for user input. In an embodiment, the input may be either a pattern of light or a signal generated by pushing one or more buttons. If after a predetermined time period input is not received, method 1300 returns to step 1304, and displays the philosophical message. When user input is received step 1310 proceeds to step 1312.

In step 1312, the time and/or date can be altered. Step 1312 may include a variety of steps and decisions that relate to setting the time, date, and/or other functions. In an embodiment, step 1312 is an edit mode that the user can stay in until the time, date, and/or other functions are set to the desired settings. In an alternative embodiment, step 1312 performs one editing step or one set of editing steps, and afterwards, method 1300 returns to step 1304, prior to allowing the user to make further edits.

In an embodiment, in steps 1310 and/or 1312 the user input must be received by the user pressing one or more buttons. Requiring the user input to be entered via buttons in steps 1310 and/or 1312 reduces the likelihood that the time will be changed by accident as a result of a random pattern of light passing over timepiece 100. In an alternative embodiment, a pattern of light may be used instead of buttons in step 1310 and/or 1312. The likelihood of a random pattern of light setting timepiece 100 may be reduced by requiring that the time be set in a multiple stages. In this embodiment, the probability of random patterns altering the time is the product of the probability of a random pattern bringing timepiece 100 to the first stage and then, while still in the first stage, the probability of another random pattern altering the time. In other embodiments, method 1300 may not include all of the steps listed above or other steps instead of and/or in addition to those listed above.

FIG. 13B shows a flowchart of an example of a method 1350 for setting timepiece 100. Step 1302, 1304, 1306, 1308, and 1312 are described in FIG. 13A. Until step 1306, the flow of methods 1300 and 1350 are identical. However, at step 1306, if a signal is received, method 1350 proceeds to step 1352 instead of step 1308. At step 1352, a determination is made as to whether the signal received is for causing timepiece 100 to display the time and/or date or edit the time, date, and/or other functions. If the signal is for displaying the time and/or date, then method 1350 proceeds to step 1308 and displays the time and/or date. If the signal is for editing the time and/or date, method 1350 proceeds to step 1312 for editing the time, date and/or other functions. After step 1308 or step 1312, method 1350 returns to step 1304 and displays the philosophical message. In other embodiments, method 1350 may not include all of the steps listed above or other steps instead of and/or in addition to those listed above.

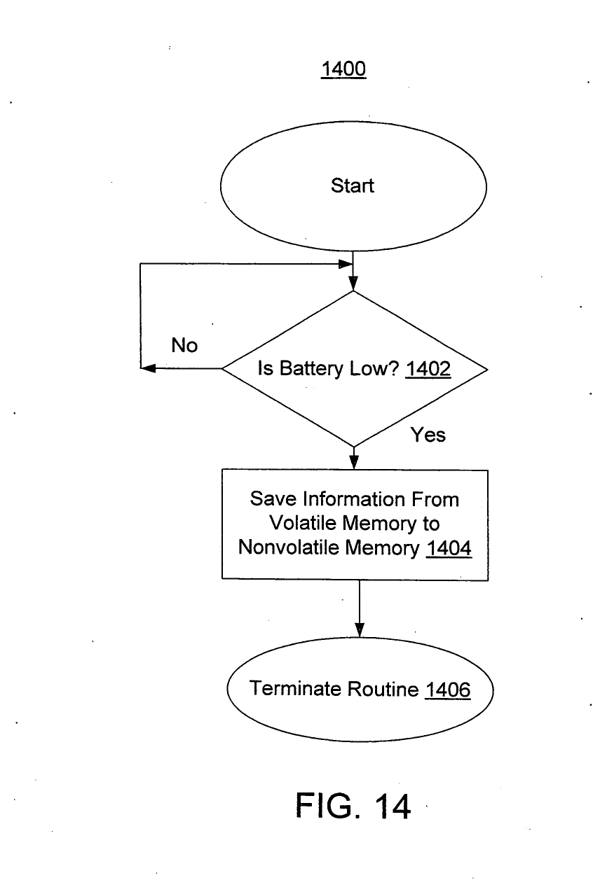

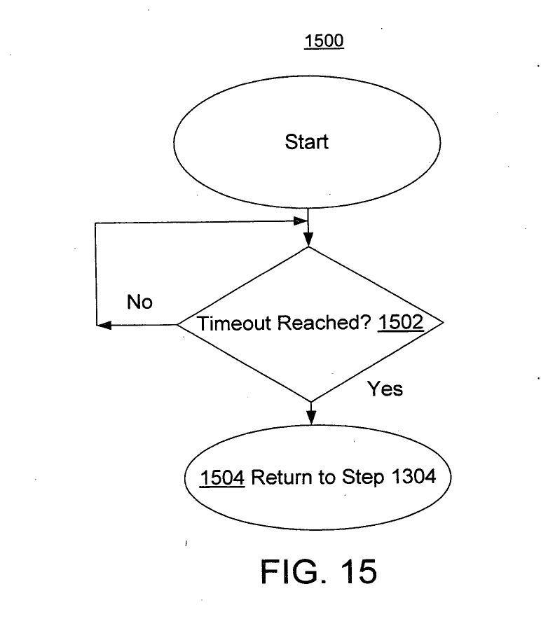

FIGS. 14 and 15 illustrate examples of methods that may be used as watchdog timers that provide escape routes that are used in the case of a low battery or a forgetful user. In an embodiment, after a given time without any entry from the user method 1300 returns to step 1304, and displays one or more philosophical messages.

FIG. 14 shows a flowchart of an example of a method 1400 for protecting the timepiece 100 when the battery is failing. Method 1400 may run in parallel with method 1300 or 1350. In step 1402, method 1400 checks whether or not the battery is low. If the battery is not low, step 1402 is repeated periodically. If the battery is low, the method proceeds to step 1404. In another embodiment, step 1402 is skipped and step 1404 is activated by the battery being low without periodically checking of the battery power. In step 1404, any data that may be lost, such as data currently stored in volatile memory is stored to nonvolatile memory. In step 1406, method 1400 is terminated. Step 1406 may involve powering down timepiece 100 to protect timepiece 100 from any possible detrimental effects that a sudden power loss may cause. Alternatively, step 1406, may involve allowing timepiece 100 to continue running until the battery runs out. In an embodiment, step 1406 involves repeating step 1404 periodically until the battery actually fails. In other embodiments, method 1400 may not include all of the steps listed above or other steps instead of and/or in addition to those listed above.

FIG. 15 shows a flowchart of an example of a method 1500 for handling timeouts. Method 1500 may be incorporated within steps 1306 (FIGS. 13A and B), 1310 (FIG. 13A), and/or 1352 (FIG. 13B). Additionally, method 1500 may be performed one or more times within step 1312 (FIGS. 13A and B). In step 1502, method 1502 checks whether a time limit was reached without receiving user input. If the time limit was not reached, step 1502 is repeated periodically. If the time limit was reached, the method proceeds to step 1504. In another embodiment, step 1502 is skipped and step 1504 is activated by the time limit being reached without receiving any user input. In step 1504, the method 1500 returns control to step 1304 of method 1300 (FIG. 13A or B), and in an embodiment the philosophical message is displayed. In other embodiments, method 1500 may not include all of the steps listed above or other steps instead of and/or in addition to those listed above.

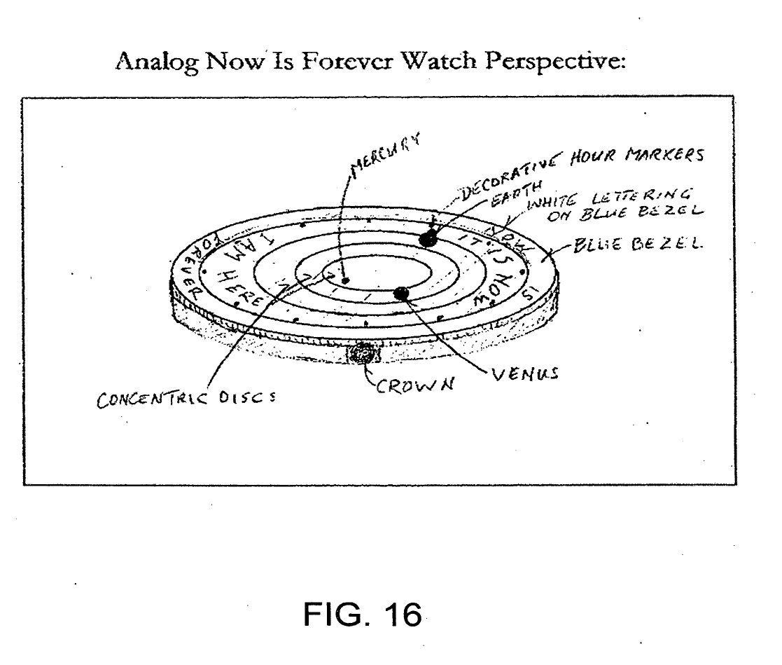

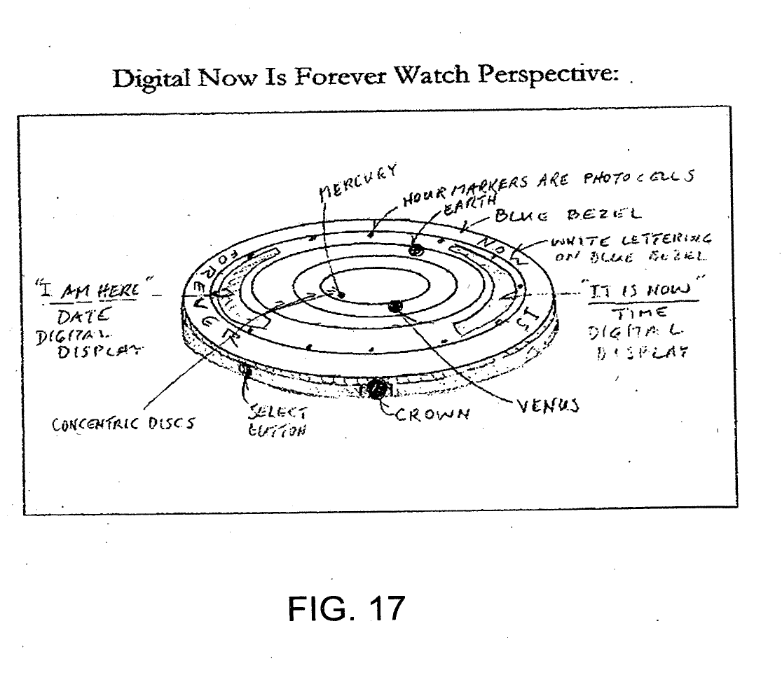

FIG. 16 is a perspective view of timepiece 100 (FIG. 1) including face 1100 (FIG. 11). FIG. 16 does not show cover 132 (FIG. 1), which is optional if an electromotor is used to propel the orbs representing the planets. FIG. 17 is a perspective view of timepiece 100 (FIG. 1) including face 1200 (FIGS. 12A and B) without cover 100.

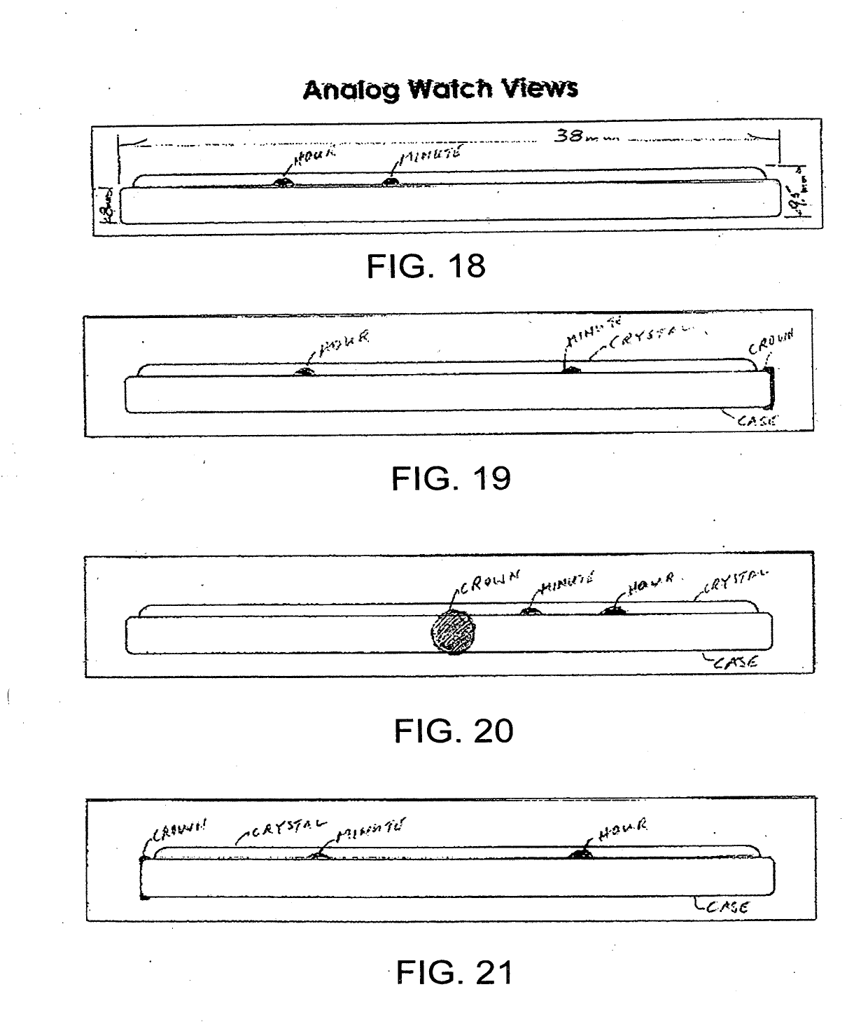

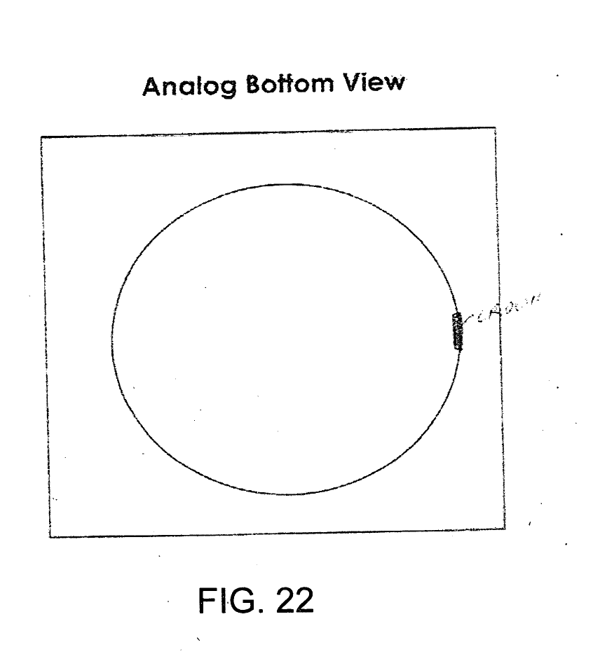

FIGS. 18-22 show different views of an embodiment of timepiece 100 that does not have a function or set button. The embodiment of FIGS. 18-21 may be an embodiment corresponding to that of FIGS. 11 and 16 (e.g., an analog embodiment). FIG. 18 is a side view opposite the crown of an embodiment of timepiece 100. FIG. 19 is a side view from the 6:00 end of an embodiment of timepiece 100. FIG. 20 is a side view from the crown end of an embodiment of timepiece 100. FIG. 21 is a side view from the 12:00 end of an embodiment of timepiece 100. FIG. 22 shows a bottom view of an embodiment of timepiece 100.

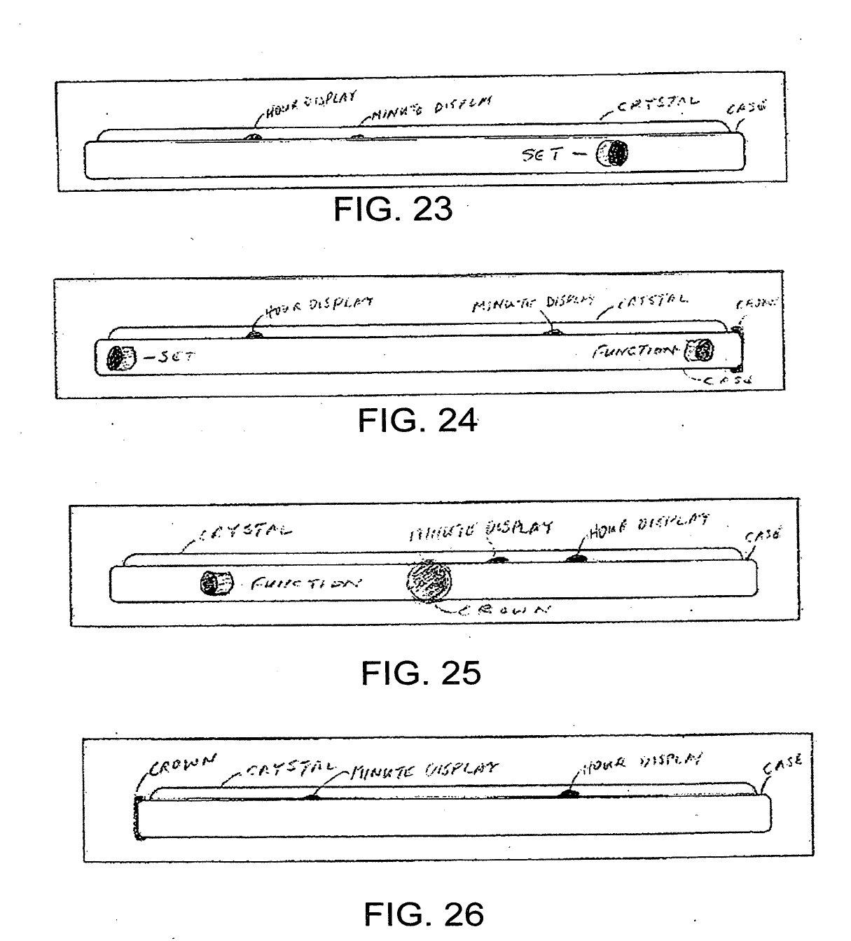

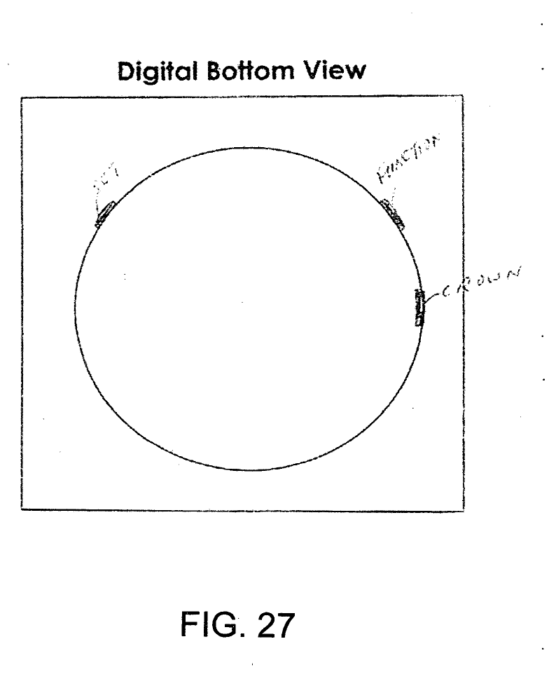

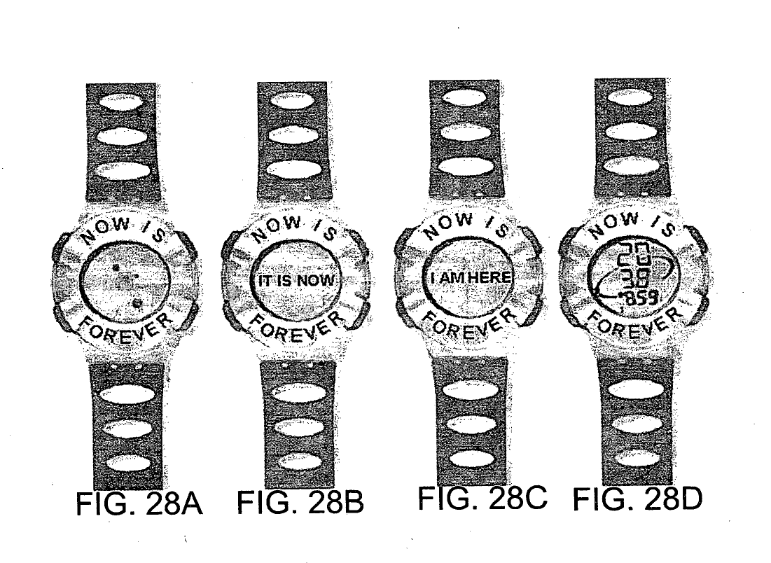

FIGS. 23-27 show different views of an embodiment of timepiece 100 that does not have a function or set button. The embodiment of FIGS. 23-27 may be an embodiment corresponding to that of FIGS. 12A, 12B, and 17 (e.g., a digital embodiment). FIG. 23 is a side view opposite the crown of an embodiment of timepiece 100. FIG. 24 is a side view from the 6:00 end of an embodiment of timepiece 100. FIG. 25 is a side view from the crown end of an embodiment of timepiece 100. FIG. 26 is a side view from the 12:00 end of and embodiment of timepiece 100. FIG. 27 shows a bottom view of an embodiment of timepiece 100.

FIGS. 28A-D show examples of various display modes of another embodiment of timepiece 100. In an embodiment, the face of timepiece 100 (as shown in FIGS. 28A-D) may be one large display cell. FIGS. 28A-D show different display modes of timepiece 100. In FIG. 28A the display of timepiece 100 shows Mercury, Venus, and Earth, which are used for displaying the time. In FIG. 28B, “IT IS NOW” is displayed. In FIG. 28C, “I AM HERE” is displayed. In FIG. 28D, a digital representation of the time is displayed. In FIGS. 18-21 and 23-26 the orb representing Mercury is hidden by the bezel.

Although FIGS. 11, 12A and B, and 28A-D illustrate watch bands, in alternative embodiments the watch bands are not present. Although information entry system 122 of FIG. 1, and the buttons and crowns of FIGS. 11, 12A and B, and 16-28D are located on the sides of timepiece 100, the crown is optional and the buttons and information entry system 122 may be located anywhere on timepiece 100 such as the back and/or front in addition to, or instead of, the sides of time piece 100.

Although the invention has been described with reference to specific embodiments, it will be understood by those skilled in the art that various changes may be made and equivalents may be substituted for elements thereof without departing from the true spirit and scope of the invention. In addition, modifications may be made without departing from the essential teachings of the invention.

1. A system comprising:
a marker system marking at least one location that is indicative of time, wherein the marker system is configured to visually suggest an orbiting planet.

2. The system of claim 1, further comprising and at least one message area displaying a philosophical message.

3. The system of claim 1, wherein the marker system comprises at least one orb attached to a rotating disc.

4. The system of claim 1, wherein the marker system comprises a first rotating disc;
a first orb attached to the first rotating disc;
a second rotating disc, wherein the second rotating disc rotates at a slower rate than the first rotating disc and the second disc is larger than the first disc; and
a second orb, which is larger than the first orb and is attached to the second rotating disc.

5. The system of claim 4, wherein the marker system further comprises:
a third rotating disc, the third rotating disc rotating at a slower rate than the second rotating disc and the third rotating disc being larger than the second rotating disc.

6. The system of claim 5,
the first rotating disc having first radius;
the second rotating disc having a second radius, the first radius having a ratio to the second radius that is substantially equal to a ratio of a first orbit associated with a first planet to a second orbit associated with a second planet; and
the third rotating disc having a third radius, the second radius having a ratio to the third radius that is substantially equal to a ratio of the second orbit to a third orbit associated with a third planet.

7. The system of claim 5,
the first orb having first diameter;
the second orb having a second diameter, the first diameter having a ratio to the second diameter that is substantially equal to a ratio of diameters of a first planet to a second planet;
and
the orb having a third diameter, the second diameter having a ratio to the third diameter that is substantially equal to a ratio of diameters of the second planet to a third planet.

8. A system comprising:
a threshold detector having at least
A) a receiver of input; and
B) a circuit that
(a) establishes a varying threshold that
(1) is derived from the input and
(2) varies with variations in the input, and
(b) detects when the input crosses the threshold.

9. The system of claim 8, wherein the threshold is a predetermined amount of deviation from an average of the input over a predetermined length of time.

10. The system of claim 8, wherein the receiver includes at least one or more photo sensors.

11. The system of claim 8, wherein the threshold includes an upper limit and a lower limit and the threshold detector detects when the input crosses the threshold by detecting when the input is no longer between the upper limit and the lower limit.

12. The system of claim 11, wherein:
A) the receiver converts the input into a first voltage that varies with variations in the input; and
B) the circuit
(a) divides the first voltage therein establishing
(1) an upper limit voltage that is of a lower voltage than the first voltage,
(2) a center voltage that is lower than the upper limit voltage, and
(3) a lower limit voltage that is lower than the upper center voltage,
(b) averages the upper limit voltage and the lower limit voltage over a predetermined length of time, therein forming an upper limit signal and a lower limit signal, which constitute the threshold, and
(c) derives a center signal from the center voltage, and
(d) detects when the center signal is of a higher voltage than the upper limit signal and when the center signal is of lower voltage than the lower limit signal and therein detects when the input crosses the threshold.

13. The system of claim 8, wherein
A) the receiver includes at least a series of photodiodes that generate a photodiode voltage; and
B) the circuit includes at least
(a) a first voltage divider having at least
(1) a first resistor, and
(2) a second resistor in series with the first resistor,
(b) a first capacitor connected
(1) in parallel with the second resistor and
(2) in series with the first resistor, wherein the first capacitor, the first resistor, and the second resistor form a filter having a first relaxation constant,
(c) a tap that is connected between the first resistor and the second resistor, therein generating a tap signal having a tap voltage that is an average voltage wherein the average voltage of the tap signal is determined by the first relaxation constant,
(d) a second voltage divider having at least
(1) a third resistor,
(2) a fourth resistor in series with the third resistor,
(3) a fifth resistor in series with the fourth resistor,
(e) a second capacitor connected
(1) in series with the third resistor,
(2) in parallel with the fourth resistor, and
(3) in parallel with the fifth resistor, wherein the second capacitor, the third resistor, and a sum of the fourth resistor and the fifth resistor form a relaxation constant that is greater than the first relaxation constant,
(f) a first connection that is connected between the third resistor and the fourth resistor, therein generating a lower limit signal having a time averaged lower limit voltage, wherein low frequency tap signals have a voltage that is higher than the time averaged lower limit voltage,
(g) a second connection that is connected between the fourth resistor and the fifth resistor, therein generating a higher limit signal having a time averaged higher limit voltage, wherein low frequency tap signals have a voltage that is lower than the higher limit voltage, wherein the lower limit signal and the time averaged higher limit signal form the threshold, and
(h) a limit sense generating an output signal indicative of whether the tap signal crossed the upper limit signal or lower limit signal.

14. The system of claim 13, further comprising:
a first rotating disc having first radius;
a first orb attached to the first rotating disc having a first diameter, the first rotating disc rotating at rate such that positions of the first orb indicate seconds;
a second rotating disc having a second radius;
a second orb having a second diameter, the second orb being attached to the second disc, the second disc rotating at a rate such that positions of the second orb indicate minutes;
a third rotating disc having a third radius;
a third orb having a third diameter, the third orb being attached to the third rotating disc, the third rotating disc rotating at a rate such that positions of the third orb indicate hours;
a ratio of the first diameter to the second diameter and third diameter being substantially equal to a ratio of the diameter of Mercury to the diameter of Venus and Earth, respectively;
a ratio of the first radius to the second radius and the third radius being substantially equal to a ratio of a radius of an orbit of Mercury to a radius of an orbit of Venus and a radius of an orbit of Earth, respectively;
a surface upon which the first rotating disc, second rotating disc, and third rotating disc are mounted, the surface having a philosophical message thereon; and
wherein the output signal is capable of affecting positions of the second orb and the third orb.

15. A method comprising:
receiving a patterned input of light at one or more locations associated with a timepiece; and
based on the patterned input, generating a patterned signal in the timepiece that affects at least one setting of the timepiece.

16. The method of claim 15 further comprising waving a hand past the timepiece to therein generate the patterned input.

17. The method of claim 16, wherein the waving of the hand includes at least waving the hand in a first direction past the timepiece; and
waving the hand in a second direction that is an opposite direction from the first direction.

18. The method of claim 17, wherein the generating of the patterned signal includes at least generating a single patterned signal from the waving of the hand in the first direction and the waving of the hand in the second direction.

19. The method of claim 16, wherein the patterned signal includes a pattern that is associated with a pattern of spaces between fingers of the hand, wherein the spaces convey information that is entered into the timepiece by the waving.

20. The method of claim 19, further comprising:
waiting for a predetermined duration of time; and
if no input is received during the predetermined duration of time, displaying a philosophical message.
